(19) United States
(12) Patent Application Publication
(10) Pub. No.: US 2010/0164554 A1
(43) Pub. Date: Jul. 1, 2010

(54) FILTER CIRCUIT, CONTINUOUS TIME FILTER, AND SIGNAL REPRODUCING APPARATUS

(75) Inventor: Isao TSUYAMA, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Toshiba Storage Device Corporation, Tokyo (JP)

(21) Appl. No.: 12/643,863

(22) Filed: Dec. 21, 2009

(30) Foreign Application Priority Data
Dec. 26, 2008 (JP) 2008-332155

(51) Int. Cl. H02M 11/00

(52) U.S. Cl. 327/103

(57) ABSTRACT

According to one embodiment, a filter circuit includes: a first circuit to convert an input voltage into a current using a transfer conductance as a conversion coefficient; a capacitor connected to an output terminal of the first circuit; a second circuit connected to the first circuit and capacitor, and configured to convert an input voltage into a current using a transfer conductance as a conversion coefficient; a setting circuit to adjust the transfer conductance of the first circuit from a first signal and a second signal for gain adjustment and generate a third signal for gain adjustment. The output terminal of the first circuit is connected to an output terminal of the second circuit from which a signal inverted with respect to a signal output from the first circuit is output, the first signal is input to the second circuit, and a frequency band is adjusted by the first signal.

### CROSS-REFERENCE TO RELATED APPLICATIONS

This application is based upon and claims the benefit of priority from Japanese Patent Application No. 2008-332155, filed on Dec. 26, 2008, the entire contents of which are incorporated herein by reference.

### BACKGROUND

1. Field

One embodiment of the invention relates to a filter circuit that is used in a signal reproducing apparatus or a communication apparatus, a continuous time filter, and the signal reproducing apparatus, and more particularly, to a filter circuit, a continuous time filter, and a signal reproducing apparatus, which have a gain control function.

2. Description of the Related Art

Filter circuits have been widely used to adjust a band of a signal. For example, a Read Channel Circuit (RDC) of a signal reproducing module of a magnetic disk apparatus is configured as illustrated in FIG. 22.

A reproduction signal from a magnetic head (not illustrated) is input to a High Pass Filter (HPF) 1000 and a low frequency component is cut. An output from the high pass filter 1000 is input to an Analog Front End (AFE) circuit 1002.

A main circuit of the AFE circuit 1002 is configured to comprise a Variable Gain Amplifier (VGA) 1004 and a Continuous Time Filter (CTF) 1006. By an external control signal, the VGA 1004 adjusts amplitude of a read signal to an optimal value, and the CTF 1006 adjusts a cutoff frequency and equalizes a waveform.

An output from the CTF 1006 is converted into a digital value by an Analog/Digital Converter (ADC) 1100 and input to a Finite Impulse Response (FIR) filter 1102. The FIR filter 1102 equalizes a PR channel and outputs an equalizing result to a Viterbi detector 1104. The Viterbi detector 1104 performs maximum-likelihood decoding and outputs a decoding result to a demodulating circuit of a Hard Disk Controller (HDC).

Meanwhile, a timing recovery circuit 1010 corrects a clock of a Time Base Generator (TBG) 1012 by an output of the FIR filter 1102 and an output of the Viterbi detector 1104, and corrects a sample clock of the ADC 1100.

An Automatic Gain Control (AGC) circuit 1020 adjusts a gain of the VGA 1004 from the output of the FIR filter 1102 and the output of the Viterbi detector 1104. A frequency adjusting (Fc Tuning) circuit 1014 generates a frequency adjustment signal from the clock of the time base generator 1012 and adjusts the frequency of the CTF 1006.

FIG. 24 illustrates the configuration of the VGA 1004 and the CTF 1006 according to the conventional technology. In this example, the VGA 1004 comprises three stages of VGAs G1 to G3, and gains are adjusted by gain adjustment signals 1 to 3 of the AGC circuits 1020, respectively.

Meanwhile, the CTF 1006 generally connects a primary low pass filter 1206 and secondary low pass filters 1200 to 1204 with multiple stages, and is configured with a scale of a seventh order (7-pole).

The CTF 1006 has a waveform equalizing function of slimming a waveform with a very broad base, in addition to a function of removing a noise. The waveform is equalized by boosting a high band. In order to boost the high band, a secondary high pass filter characteristic is used. Therefore, the CTF is configured by combining a low pass filter to remove a noise and a high pass filter to equalize a waveform.

Meanwhile, since the high pass filter has zero, the high pass filter affects a high pass cutoff characteristic of the low pass filter. In the case of the low pass filter, an attenuation inclination of the high band is determined by an order (pole number), but existence of the zero may cause poles to be offset. For example, an attenuation inclination of a tertiary low pass filter is −18 dB/oct, but when a secondary high pass filter function is added thereto, the attenuation inclination of the high band becomes −6 dB/oct, and the same performance as that of the primary low pass filter may be obtained.

For this reason, in order to secure a sufficient noise removing function, in the CTF 1006, a high-order filter circuit is generally used. In an actual hard disk drive, a seventh-order filter is generally used. In the case of the seventh-order filter, even though the seventh-order filter has two zeros as an equalizing function, a fifth-order attenuation inclination can be secured.

Next, a primary low pass filter according to the conventional technology will be described. FIG. 25 is a block diagram of a transfer function of a primary low pass filter, and FIG. 26 illustrates the configuration of a Gₘ-C circuit of the primary low pass filter. A transfer function T₁ₚ₁(S) of the primary low pass filter is given by the following Equation 1.

$${T}_{LP 1} ( S ) = \frac{{ω}_{0}}{S + {ω}_{0}} = \frac{\frac{{ω}_{0}}{S}}{1 + \frac{{ω}_{0}}{S}} \qquad ( 1 )$$

In Equation 1, ω₀ is a unique angular frequency [rad/sec], and corresponds to a low pass cutoff frequency of a primary low pass filter. S is a Laplace operator.

FIG. 25 illustrates the block configuration of a primary low pass filter that is derived from a transfer function of Equation 1. If a transfer conductance circuit Gₘ is used, the unique angular frequency ω₀ can be represented by a ratio of capacitance C and transfer conductance Gₘ, as represented by the following Equation 2.

$${ω}_{0} = \frac{{G}_{m}}{C} \qquad ( 2 )$$

If Equation 2 is substituted for Equation 1, a transfer function of a primary low pass filter can be transformed as represented by the following Equation 3.

$$\begin{matrix}{T}_{LP 1} ( S ) = \frac{{V}_{out}}{{V}_{i n}} \\ = \frac{\frac{{G}_{m}}{S \cdot C}}{1 + \frac{{G}_{m}}{S \cdot C}} ⇒ {V}_{out} \\ = \frac{{G}_{m}}{S \cdot C} \cdot ( {V}_{i n} - {V}_{out} )\end{matrix} \qquad ( 3 )$$

FIG. 26 is a circuit diagram of a primary low pass filter composed of a Gₘ-C circuit that can be derived from Equation 3, when a perfect integrator is configured using transfer conductance Gₘ and capacitance C.

In FIG. 26, a pair of transfer conductance circuits 1206-1 and 1206-2 are connected in series. The transfer conductance circuit 1206-2 at the output side operates a difference between an input Vᵢₙ, and an output Vₒᵤₜ. Frequencies of the transfer conductance circuits 1206-1 and 1206-2 are adjusted by an input control frequency Cont_Fc.

Next, a secondary low pass filter according to the conventional technology will be described. FIG. 27 is a block diagram of a transfer function of a secondary low pass filter, and FIG. 28 illustrates the configuration of a Gₘ-C circuit of the secondary low pass filter. The transfer function of the secondary low pass filter is represented by the following Equation 4. In Equation 4, ω₀ is a resonant angular frequency [rad/sec], Q is a parameter that indicates selectivity or resonance sharpness, and a gain at the frequency ω₀ becomes a Q value.

$$\begin{matrix}\frac{{V}_{out} ( S )}{{V}_{i n} ( S )} = \frac{{ω}_{0}^{2}}{{S}^{2} + \frac{{ω}_{0}}{Q} \cdot S + {ω}_{0}^{2}} \\ = \frac{\frac{{ω}_{0}^{2}}{S \cdot ( S + \frac{{ω}_{0}}{Q} )}}{1 + \frac{{ω}_{0}^{2}}{S \cdot ( S + \frac{{ω}_{0}}{Q} )}} ≡ \frac{μ}{1 + μ \cdot β}\end{matrix} \qquad ( 4 )$$

As illustrated at the right side of Equation 4, when the secondary low pass filter is configured as a negative feedback system, a forward transfer gain μ and a feedback gain β are as represented by the following Equation 5.

$$\{ \begin{matrix}μ = \frac{{ω}_{0}^{2}}{S \cdot ( S + \frac{{ω}_{0}}{Q} )} = \frac{Q \cdot {ω}_{0}}{S} \cdot \frac{\frac{{ω}_{0}}{S \cdot Q}}{1 + \frac{{ω}_{0}}{S \cdot Q}} \\ β = 1\end{matrix} \qquad ( 5 )$$

As illustrated in FIG. 27, in the block diagram of the transfer function, a circuit is composed of a Unity-Feedback circuit of a feedback gain β=1. The right side of an expression of μ in Equation 5 indicates the configuration where a perfect integrator ((Q·ω₀)/S) 1202A and a local Unity-Feedback circuit 1202B using a perfect integrator (ω₀/(S·Q)) are cascade connected, as illustrated in FIG. 27.

Similar to the case of the primary low pass filter, when the perfect integrator is configured using transfer conductance Gₘ and capacitance C, a correspondence relationship between the parameters ω₀ and Q in the individual stages of FIG. 27 becomes a relationship represented by the following Equation 6.

$$\begin{matrix}Q \cdot {ω}_{0} = \frac{{G}_{m 1}}{{C}_{1}} \\ \frac{{ω}_{0}}{Q} = \frac{{G}_{m 2}}{{C}_{2}}\end{matrix} \} \qquad ( 6 )$$

If Equation 6 is substituted for Equation 4, a transfer function of a secondary low pass filter can be substituted by the transfer conductance Gₘ and the capacitance C, as represented by the following Equation 7.

$$\begin{matrix}\frac{{V}_{out} ( S )}{{V}_{i n} ( S )} = \frac{\frac{{G}_{m 1} \cdot {G}_{m 2}}{{C}_{1} \cdot {C}_{2}}}{{S}^{2} + \frac{{G}_{m 2}}{{C}_{2}} \cdot S + \frac{{G}_{m 1} \cdot {G}_{m 2}}{{C}_{1} \cdot {C}_{2}}} \\ = \frac{( \frac{{G}_{m 1}}{S \cdot {C}_{1}} ) \cdot ( \frac{{G}_{m 2}}{S \cdot {C}_{2}} )}{1 + \frac{{G}_{m 2}}{S \cdot {C}_{2}} + ( \frac{{G}_{m 1}}{S \cdot {C}_{1}} ) \cdot ( \frac{{G}_{m 2}}{S \cdot {C}_{2}} )}\end{matrix} \qquad ( 7 )$$

From the transfer function of Equation 7, the configuration of a Gₘ-C circuit is derived. For this reason, a potential equation is made in consideration of an accumulated charge for every capacitance C. At this time, if an internal virtual potential Vₓ is assumed, the following two relational expressions (Equations 8 and 9) can be obtained between an output Vₒᵤₜ, a virtual potential Vₓ, and an input Vᵢₙ, for every capacitance C.

$$\begin{matrix}\begin{matrix}{V}_{out} = \frac{{G}_{m 2}}{S \cdot {C}_{2}} [ \frac{{G}_{m 1}}{S \cdot {C}_{1}} \cdot ( {V}_{i n} - {V}_{out} ) - {V}_{out} ] \\ = \frac{{G}_{m 2}}{S \cdot {C}_{2}} \cdot ( {V}_{x} - {V}_{out} )\end{matrix} & ( 8 ) \\ {V}_{x} = \frac{{G}_{m 1}}{S \cdot {C}_{1}} \cdot ( {V}_{i n} - {V}_{out} ) & ( 9 )\end{matrix}$$

In the cases of Equations 8 and 9, a contact potential of a capacitor C₁ becomes a virtual potential Vₓ. The configuration of a Gₘ-C circuit of a secondary low pass filter that is derived by Equations 8 and 9 is illustrated in FIG. 28.

That is, in order to realize Equation 9, a pair of transfer conductance circuits 1202-1 and 1202-2 are connected in series. In order to realize Equation 8, a pair of transfer conductance circuits 1202-3 and 1202-4 are connected in series.

As illustrated in FIG. 24, the CTF 1006 is realized by configuring primary and secondary low pass filters with multiple stages. For example, in the case of a seventh CTF, secondary low pass filters are configured with three stages and a primary low pass filter is configured with one stage.

The CTF 1006 has a function of equalizing amplitude, in addition to a function as a simple low pass filter. In FIG. 24, one secondary low pass filter constitutes an equalizing circuit 1200. The equalizing circuit 1200 adds zero to a transfer function, and operates a gain-frequency characteristic using a characteristic of a secondary High Pass Filter (HPF) or a Band Pass Filter (BPF).

FIG. 23 illustrates the configuration of a Gₘ-C circuit of the equalizing circuit 1200 according to the conventional technology. As illustrated in FIG. 23, in the previous stages of transfer conductance circuits 1200-4 to 1200-7 that constitute the secondary low pass filter of FIG. 28, three amplifying stages (amplifying amplifiers) 1200-1 to 1200-3 are provided.

As such, it has been suggested that the primary filter circuit has a function of adjusting a gain (for example, Japanese Patent Application Publication (KOKAI) No. 6-237146 (FIG. 10)). Japanese Patent Application Publication (KOKAI) No. 6-237146 suggests a primary low pass filter that is composed of a variable mutual conductance amplifier and has a variable cutoff frequency, which corresponds to a system that adjusts a gain by a Gₘ₁ and a cutoff frequency by a Gₘ₂.

In recent years, with a high recording density of a hard disk drive, a signal speed also increases. In order to achieve a high-speed operation and low power consumption, a size of an integrating circuit element decreases. However, in order to improve a signal quality, a circuit technology needs to be studied.

In the analog front end 1002 according to the conventional technology, since a frequency adjusting function and a gain adjusting function are clearly separated from each other, a signal passes through a large number of circuits. From a viewpoint of waveform equalization, in the VGA 1004, a frequency band is preferably ignored.

However, in actuality, a band of each of amplifying stages of the VGA is finite. That is, the VGA has unnecessary poles.

As illustrated in FIG. 29, if a position of a pole of the VGA as a high band is sufficiently away from a frequency band to be covered by the CTF 1006, a problem is not generated.

However, if a signal speed increases and a high band component to be covered by the CTF 1006 increases, the pole of the VGA cannot be ignored, thereby affecting a frequency characteristic of the CTF 1006. As a result, an equalization error is deteriorated.

That is, if a transfer function of the CTF 1006 is E (S) and a transfer function of another analog circuit module comprising the VGA 1004 is A(S), an entire amplitude characteristic is represented in a form of multiplication like E(S)×A(S).

Only in a region where A(S) can be regarded as a flat amplitude characteristic with respect to a frequency, E(S) is effectively functioned. For this reason, with respect to a frequency band of the CTF 1006, a high pass cutoff frequency of another VGA 1004 needs to be sufficiently high. If the band of the CTF 1006 is approached to a cutoff frequency band of the VGA 1004, the CTF 1006 interferes with the VGA 1004.

As illustrated in FIG. 29, when the transfer speed is low, the band of the VGA 1004 can be regarded to be sufficiently high, and an influence of a frequency band restriction of the VGA 1004 can be ignored.

However, when the transfer speed increases, the frequency characteristic of the VGA 1004 can be gradually ignored. The interference by the VGA 1004 causes a signal quality to be deteriorated. Accordingly, in order to achieve the high-speed operation, it is important to greatly decrease a signal pass element causing an extra band restriction, in the analog circuit.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary view of the configuration of an embodiment of a primary low pass filter according to the invention;

FIG. 2 is an exemplary view of the configuration of a Gₘ block of FIG. 1;

FIG. 3 is an exemplary circuit diagram of a transfer conductance circuit of FIG. 2;

FIG. 4 is an exemplary circuit diagram of a bias circuit of FIG. 2;

FIG. 5 is an exemplary circuit diagram of a coefficient setting circuit of FIG. 1;

FIG. 6 is an exemplary view of the configuration of a complex control Gₘ block of another embodiment of a primary low pass filter according to the invention;

FIG. 7 is an exemplary view of the configuration of the another embodiment of the primary low pass filter;

FIG. 8 is an exemplary view of the configuration of a complex control Gₘ block of FIG. 7;

FIG. 9 is an exemplary view of a Gₘ adjustment of a complex control Gₘ block of FIG. 8;

FIG. 10 is an exemplary circuit diagram of a multiple-stage-type Gₘ circuit of FIG. 7;

FIG. 11 is an exemplary circuit diagram of a switch circuit of FIG. 7;

FIG. 12 is an exemplary view of the configuration of an embodiment of a secondary low pass filter according to the invention;

FIG. 13 is an exemplary view of the configuration of another embodiment of a secondary low pass filter according to the invention;

FIG. 14 is an exemplary view of the configuration of an embodiment of a secondary band pass filter serving as an equalizer element according to the invention;

FIG. 15 is an exemplary view of the configuration of an embodiment of a secondary high pass filter serving as an equalizer element according to the invention;

FIG. 16 is an exemplary view of the configuration of an embodiment of an equalizing circuit according to the invention;

FIG. 17 is an exemplary view of the configuration of another embodiment of an equalizing circuit according to the invention;

FIG. 18 is an exemplary block diagram of an embodiment of a signal reproducing apparatus according to the invention;

FIG. 19 is an exemplary block diagram of an embodiment of a continuous time filter of FIG. 18;

FIG. 20 is an exemplary block diagram of another embodiment of a continuous time filter of FIG. 18;

FIG. 21 is an exemplary circuit diagram of a reference current source suitable for a filter according to the invention;

FIG. 22 is an exemplary block diagram of a conventional signal reproducing apparatus;

FIG. 23 is an exemplary block diagram of an equalizing circuit of a conventional continuous time filter;

FIG. 24 is an exemplary block diagram of a conventional analog front end portion;

FIG. 25 is an exemplary block diagram of a transfer function of a conventional primary low pass filter;

FIG. 26 is an exemplary block diagram of a Gₘ-C circuit of a conventional primary low pass filter;

FIG. 27 is an exemplary block diagram of a transfer function of a conventional secondary low pass filter;

FIG. 28 is an exemplary block diagram of a Gₘ-C circuit of a conventional secondary low pass filter; and

FIG. 29 is an exemplary view of an AGC of a conventional analog front end and a control band of a continuous time filter.

### DETAILED DESCRIPTION

Various embodiments according to the invention will be described hereinafter with reference to the accompanying drawings. In general, according to one embodiment of the invention, a filter circuit comprises: a first voltage/current converting circuit configured to convert an input voltage into a current using a transfer conductance as a conversion coefficient; a capacitor connected to an output terminal of the first voltage/current converting circuit; a second voltage/current converting circuit connected to the first voltage/current converting circuit and the capacitor, and configured to convert an input voltage into a current using a transfer conductance as a conversion coefficient; a coefficient setting circuit configured to adjust the transfer conductance of the first voltage/current converting circuit from a first control signal and a second control signal for gain adjustment and generate a third signal for gain adjustment. The output terminal of the first voltage/current converting circuit is connected to an output terminal of the second voltage/current converting circuit from which a signal inverted with respect to a signal output from the first voltage/current converting circuit is output, the first control signal is input to the second voltage/current converting circuit, and a frequency band is adjusted by the first control signal.

According to another embodiment of the invention, a filter circuit comprises: a first voltage/current converting circuit configured to convert an input voltage into a current using a transfer conductance as a conversion coefficient; a capacitor connected to an output terminal of the first voltage/current converting circuit; a second voltage/current converting circuit connected to the first voltage/current converting circuit and the capacitor, and configured to convert an input voltage into a current using a transfer conductance as a conversion coefficient; a coefficient setting circuit configured to adjust the transfer conductance of the first voltage/current converting circuit from a first control signal and a second control signal for gain adjustment and generate a third signal for gain adjustment. The output terminal of the first voltage/current converting circuit is connected to an output terminal of the second voltage/current converting circuit from which a signal inverted with respect to a signal output from the first voltage/current converting circuit is output, a fourth signal for frequency adjustment and the third signal are input to the first voltage/current converting circuit, and the fourth signal and the first control signal are input to the second voltage/current converting circuit.

According to still another embodiment of the invention, a continuous time filter for waveform equalization comprises a primary low pass filter; a secondary low pass filter; and a secondary variable equalizing circuit. Each of the primary low pass filter, the secondary low pass filter, and the secondary variable equalizing circuit comprises a filter circuit comprising a first voltage/current converting circuit configured to convert an input voltage into a current using a transfer conductance as a conversion coefficient; a capacitor connected to an output terminal of the first voltage/current converting circuit; a second voltage/current converting circuit connected to the first voltage/current converting circuit and the capacitor, and configured to convert an input voltage into a current using a transfer conductance as a conversion coefficient; a coefficient setting circuit configured to adjust the transfer conductance of the first voltage/current converting circuit from a first control signal and a second control signal for gain adjustment and generate a third signal for gain adjustment. The output terminal of the first voltage/current converting circuit is connected to an output terminal of the second voltage/current converting circuit from which a signal inverted with respect to a signal output from the first voltage/current converting circuit is output, the first control signal is input to the second voltage/current converting circuit, and a frequency band is adjusted by the first control signal.

According to still another embodiment of the invention, a continuous time filter for waveform equalization comprises: a primary low pass filter; a secondary low pass filter; and a secondary variable equalizing circuit. Each of the primary low pass filter, the secondary low pass filter, and the secondary variable equalizing circuit comprises a filter circuit comprising: a first voltage/current converting circuit configured to convert an input voltage into a current using a transfer conductance as a conversion coefficient; a capacitor connected to an output terminal of the first voltage/current converting circuit; a second voltage/current converting circuit connected to the first voltage/current converting circuit and the capacitor, and configured to convert an input voltage into a current using a transfer conductance as a conversion coefficient; a coefficient setting circuit configured to adjust the transfer conductance of the first voltage/current converting circuit from a first control signal and a second control signal for gain adjustment and generate a third signal for gain adjustment. The output terminal of the first voltage/current converting circuit is connected to an output terminal of the second voltage/current converting circuit from which a signal inverted with respect to a signal output from the first voltage/current converting circuit is output, a fourth signal for frequency adjustment and the third signal are input to the first voltage/current converting circuit, and the fourth signal and the first control signal are input to the second voltage/current converting circuit.

According to still another embodiment of the invention, a signal reproducing apparatus comprises: a continuous time filter including a primary low pass filter, a secondary low pass filter, and a secondary variable equalizing circuit and configured to adjust a level of an input signal and perform waveform equalization; an automatic gain control circuit configured to generate a gain adjustment signal of the continuous time filter from an output of the continuous time filter; and a frequency adjusting circuit configured to output a frequency adjustment signal of the continuous time filter. Each of the primary low pass filter, the secondary low pass filter, and the secondary variable equalizing circuit comprises a filter circuit comprising: a first voltage/current converting circuit configured to convert an input voltage into a current using a transfer conductance as a conversion coefficient; a capacitor connected to an output terminal of the first voltage/current converting circuit; a second voltage/current converting circuit connected to the first voltage/current converting circuit and the capacitor, and configured to convert an input voltage into a current using a transfer conductance as a conversion coefficient; a coefficient setting circuit configured to adjust the transfer conductance of the first voltage/current converting circuit from a first control signal and a second control signal for gain adjustment and generate a third signal for gain adjustment. The output terminal of the first voltage/current converting circuit is connected to an output terminal of the second voltage/current converting circuit from which a signal inverted with respect to a signal output from the first voltage/current converting circuit is output, the first control signal is input to the second voltage/current converting circuit, and a frequency band is adjusted by the first control signal.

According to still another embodiment of the invention, a signal reproducing apparatus comprises: a continuous time filter including a primary low pass filter, a secondary low pass filter, and a secondary variable equalizing circuit and configured to adjust a level of an input signal and perform waveform equalization; an automatic gain control circuit configured to generate a gain adjustment signal of the continuous time filter from an output of the continuous time filter; and a frequency adjusting circuit configured to output a frequency adjustment signal of the continuous time filter. Each of the primary low pass filter, the secondary low pass filter, and the secondary variable equalizing circuit comprises a filter circuit comprising: a first voltage/current converting circuit configured to convert an input voltage into a current using a transfer conductance as a conversion coefficient; a capacitor connected to an output terminal of the first voltage/current converting circuit; a second voltage/current converting circuit connected to the first voltage/current converting circuit and the capacitor, and configured to convert an input voltage into a current using a transfer conductance as a conversion coefficient; a coefficient setting circuit configured to adjust the transfer conductance of the first voltage/current converting circuit from a first control signal and a second control signal for gain adjustment and generate a third signal for gain adjustment. The output terminal of the first voltage/current converting circuit is connected to an output terminal of the second voltage/current converting circuit from which a signal inverted with respect to a signal output from the first voltage/current converting circuit is output, a fourth signal for frequency adjustment and the third signal are input to the first voltage/current converting circuit, and the fourth signal and the first control signal are input to the second voltage/current converting circuit.

Hereinafter, embodiments of the invention will be described in the order of a first embodiment of a primary filter, a second embodiment of a primary filter, a secondary filter, an equalizing circuit, a signal reproducing apparatus, and another embodiment. However, the invention is not limited to the embodiments.

### First Embodiment of a Primary Filter

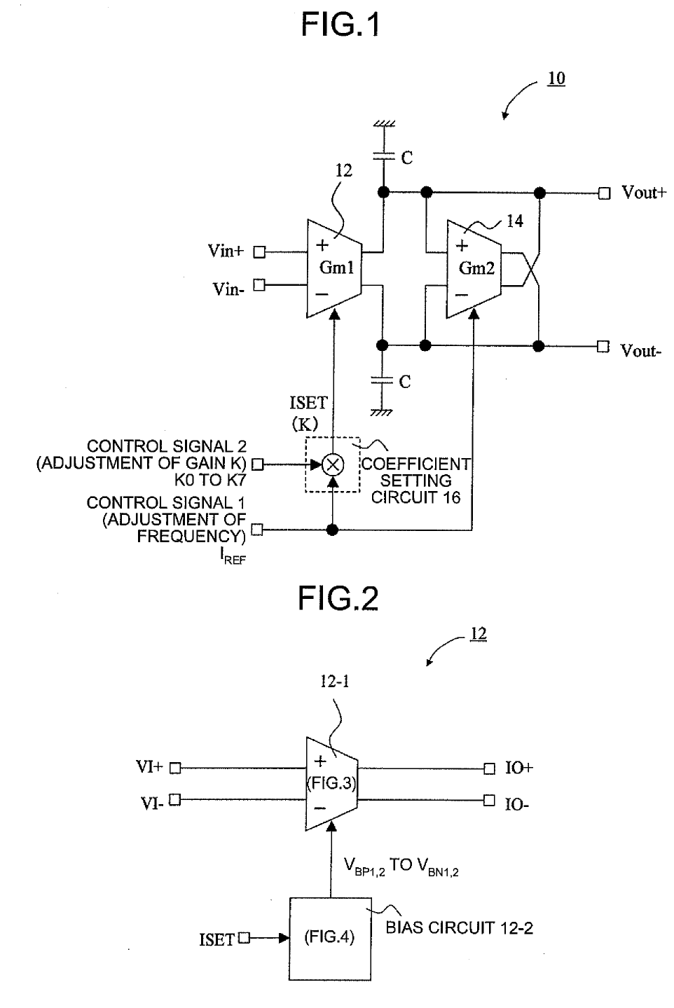

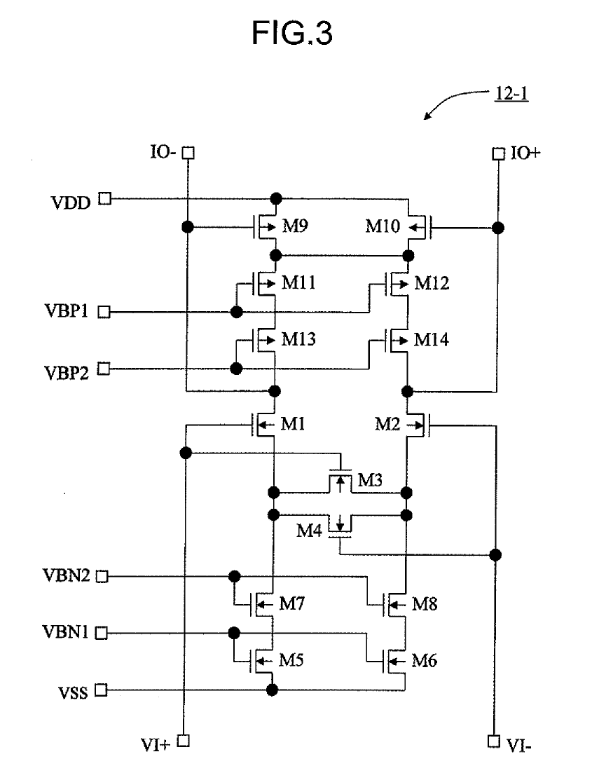

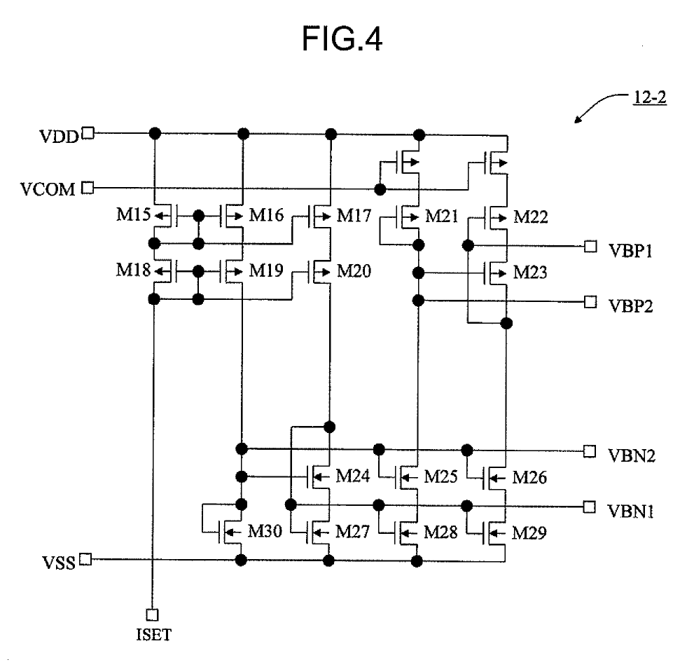

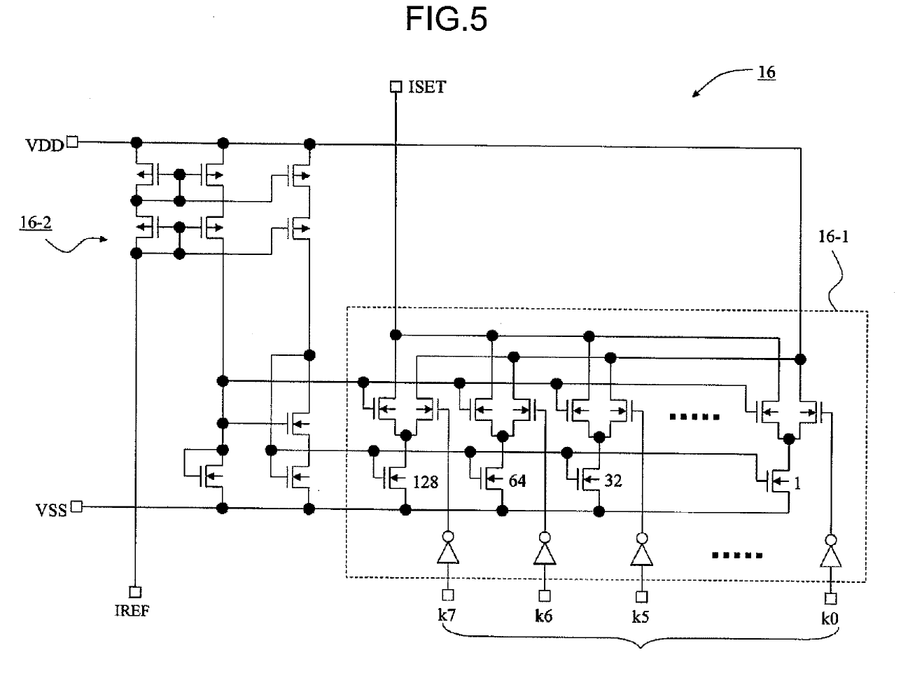

FIG. 1 is a block diagram of the configuration of an embodiment of a primary low pass filter of the invention, FIG. 2 is a block diagram of a Gₘ block of FIG. 1, FIG. 3 is a circuit diagram of a transfer conductance circuit of FIG. 2, FIG. 4 is a circuit diagram of a bias circuit of FIG. 2, and FIG. 5 is a circuit diagram of a coefficient setting circuit for a gain adjustment of FIG. 1.

In order to apply a gain adjusting function to a filter, a transfer function T_{LP1}(S) that is a ratio between an input Vᵢₙ and an output Vₒᵤₜ of FIG. 1 becomes the following Equation 10 by multiplying Equation 1 by a gain K.

$$\begin{matrix}{T}_{LP 1} ( S ) = \frac{{V}_{out}}{{V}_{i n}} \\ = K \cdot \frac{{ω}_{0}}{S + {ω}_{0}} \\ = \frac{{G}_{m 1}}{{G}_{m 2}} \cdot \frac{\frac{{G}_{m 2}}{C}}{S + \frac{{G}_{m 2}}{C}} \\ = \frac{\frac{{G}_{m 1}}{S \cdot C}}{1 + \frac{{G}_{m 2}}{S \cdot C}}\end{matrix} \qquad ( 10 )$$

In Equation 10, K is a parameter to apply a gain, and is given as a ratio of Gₘ₂ and Gₘ₁ that are constituent elements of a filter, as represented by Equation 10, without using a dedicated amplifying circuit.

Also, K has a relationship of the following Equation 11 to maintain a proportional relationship between Gₘ₁ and Gₘ₂, and cause frequency control and gain control to be independent from each other.

$$\begin{matrix}{ω}_{0} = \frac{{G}_{m 2}}{C} \\ K = \frac{{G}_{m 1}}{{G}_{m 2}} = \frac{K \cdot {G}_{m 2}}{{G}_{m 2}}\end{matrix} \} \qquad ( 11 )$$

In Equation 11, the gain K and a frequency ω₀ are separated from each other by subordinating Gₘ₁ with respect to Gₘ₂. That is, a filter gain is uniformly determined by the gain K, regardless of the frequency.

In consideration of a charge accumulated in the capacitor C of FIG. 1, similar to Equation 3, if a relationship between the output Vₒᵤₜ and the input Vᵢₙ is calculated from Equation 10, the following Equation 12 is obtained.

$${V}_{out} = \frac{1}{S \cdot C} \cdot ( {G}_{m 1} \cdot {V}_{i n} - {G}_{m 2} \cdot {V}_{out} ) \qquad ( 12 )$$

FIG. 1 illustrates a primary low pass filter circuit that is composed of a Gₘ-C circuit to realize Equation 12. That is, a primary low pass filter 10 comprises a first voltage/current converting circuit (Gₘ₁) 12 that can adjust transfer conductance by a voltage or a current, a second voltage/current converting circuit (Gₘ₂) 14 that can adjust transfer conductance, a capacitor C, and a coefficient setting circuit 16 where gain control is enabled by an external signal.

An output terminal of the first voltage/current converting circuit 12 is connected to the capacitor C, an input terminal of the second voltage/current converting circuit 14, and an output terminal of the second voltage/current converting circuit 14 whose signal is inverted with respect to a signal of the first voltage/current converting circuit 12. Thus the output terminal of the first voltage/current converting circuit 12 is connected to the output terminal of the second voltage/current converting circuit 14, from which an output signal inverted with respect to an output signal from the first voltage/current converting circuit 12 is output.

A control signal 1 (frequency adjustment signal) is input to a control terminal of the second voltage/current converting circuit 14, and the control signal 1 (frequency adjustment signal) is input to a control terminal of the first voltage/current converting circuit through the coefficient setting circuit 16.

A current of the control signal 1 adjusts a frequency ω₀. The coefficient setting circuit 16 increases a control current of the control signal 1 coefficient times by a control signal 2 to adjust a gain. That is, as illustrated in Equation 11, the frequency ω₀ independently adjusts the gain K.

As compared with the configuration of FIG. 26 described in the conventional technology, in addition to the frequency adjustment (Gₘ adjustment 1) according to the conventional technology, the control signal 2 is added to adjust the gain. However, the dedicated amplifying circuit to adjust the gain is not used, and the number of stages that a signal passes does not increase.

Meanwhile, the primary low pass filter that is composed of the variable mutual conductance amplifiers Gₘ₁ and Gₘ₂ disclosed in Japanese Patent Application Publication (KOKAI) No. 6-237146 descried in the conventional technology directly inputs a gain adjustment signal to Gₘ₁ (1206-1) and a frequency adjustment signal to Gₘ₂ (1206-2), in the configuration illustrated in FIG. 26.

In the description of the paragraph [0075] of Japanese Patent Application Publication (KOKAI) No. 6-237146, the gain can be varied by controlling Gₘ₁ by the gain control signal without affecting the cutoff frequency of the filter.

However, according to the examination of the inventors, the description in the conventional technology is not precisely correct. That is, in the document according to the conventional technology, Equation 7 of the filter gain A and Equation 8 of the cutoff frequency fc are described. These Equations 7 and 8 are described again using Equations 13 and 14.

$$\begin{matrix}A = 20 \cdot {log}_{10} ( \frac{{G}_{m 1}}{{G}_{m 2}} ) & ( 13 ) \\ fc = \frac{{G}_{m 2}}{π \cdot C} & ( 14 )\end{matrix}$$

In this case, if Equation 13 (Equation 7 in the document according to the conventional technology) is substituted for Equation 14 (Equation 8 in the document according to the conventional technology), as the cutoff frequency fc, the following Equation 15 is obtained.

$$fc = \frac{1}{π \cdot C} \cdot \frac{{G}_{m 1}}{A} \qquad ( 15 )$$

When the condition where an arbitrary predetermined filter gain A is obtained from Equation 15 is set, the cutoff frequency fc is affected by Gₘ₁. In order to cause the cutoff frequency not to be affected by Gₘ₁ even though Gₘ₁ is varied, the gain A needs to be varied in proportional to Gₘ₁.

That is, when the gain is varied, this means that Gₘ₂ needs to be varied together with Gₘ₁, as illustrated in Equation 13 (Equation 7 described in the document according to the conventional technology).

In contrast, if Equation 14 (Equation 8 described in the document according to the conventional technology) is substituted for Equation 13 (Equation 7 described in the document according to the conventional technology), the gain A is represented by the following Equation 16.

$$A = 20 \cdot {log}_{10} ( \frac{{G}_{m 1}}{π \cdot C \cdot fc} ) \qquad ( 16 )$$

As apparent from Equation 16, the gain can be adjusted by Gₘ₁, but a gain value depends on the cutoff frequency. That is, when the same gain A needs to be obtained, a needed value of Gₘ₁ becomes different according to a value of the cutoff frequency fc.

In this case, a value of Gₘ₁ of when the gain A1 needs to be obtained at an arbitrary cutoff frequency fcl is Gₘ₁. Next, when the cutoff frequency is increased to be two times larger than the existing cutoff frequency, in the same value of Gₘ₁, the gain may decrease to the half as much. In order to maintain the value of the gain A1, the value of Gₘ₁ needs to be changed to a value two times larger than the existing value.

In brief, Gₘ₂ is applied as an absolute value in the cutoff frequency (Equation 8), but in the filter gain (Equation 7), Gₘ₂ is applied in a form of a ratio with Gₘ₁. For this reason, Gₘ₂ affects both the cutoff frequency and the gain, and the cutoff frequency and the gain cannot be controlled in a perfectly independent form using only Gₘ₁, except for Gₘ₂.

The gain or the cutoff frequency of the filter is generally varied by controlling the mutual conductance Gₘ by an operation current of the circuit. However, from a viewpoint of the circuit, a range of Gₘ that can be controlled without depending on the gain or the cutoff frequency, that is, a variable range of the operation current is limited.

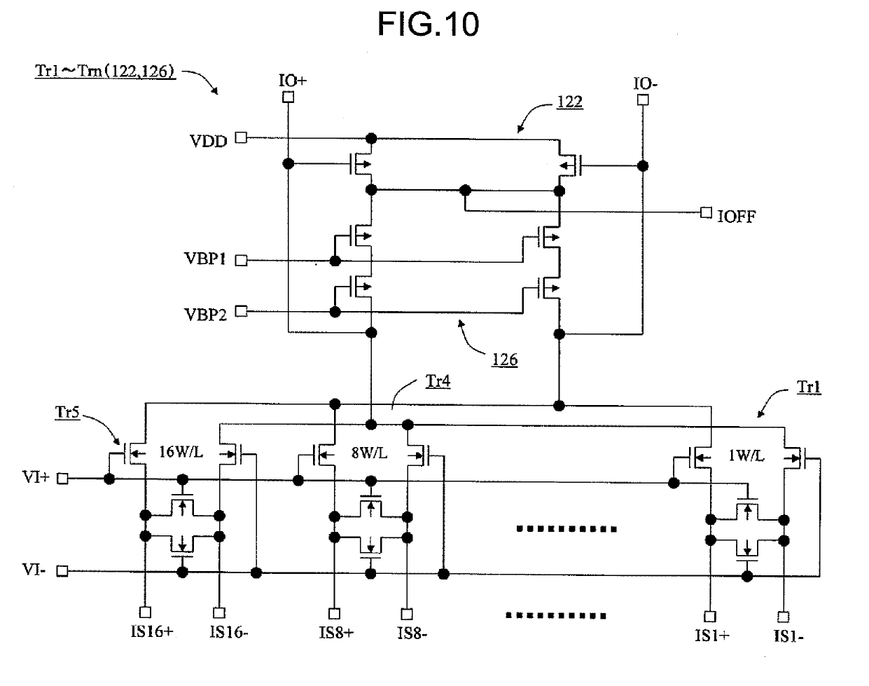

Even though the gain adjustment and the frequency adjustment are in an independent relationship to overcome the problem of FIG. 10 in the document according to the conventional technology, if an allowable variable width of Gₘ is ΔGₘ₋ₘₐₓ, a variable amount of Gₘ needed to adjust the gain is ΔG_{m-gain}, and a variable amount of Gₘ needed to adjust the same frequency is ΔG_{m-fc}, a restriction of the following Equation 17 is maintained between the individual parameters.

ΔGₘₐₓ=ΔG_{m-gain}×ΔG_{m-fc=const} (17)

For example, it is assumed that an allowable Gₘ variable range (ΔGₘ₋ₘₐₓ) of the circuit is four times. When the gain control is not performed, a frequency adjustment range (ΔG_{m-fc}) becomes four times. However, if a gain adjustment range (ΔG_{m-gain}) is set to become two times, the frequency adjustment range decreases to 4/2=2 times. That is, an adjustment range is confused.

Accordingly, as in the embodiment, a perfectly independent adjustment is enabled by the coefficient setting circuit 16 without the mutual interference between the frequency adjustment and the gain adjustment. As a result, an adjustment operation can be easily performed, and the automatic adjustment in the above-described CTF can be realized without the interference.

As illustrated in FIG. 2, the Gₘ block 12 (14) of FIG. 1 comprises a transfer conductance circuit 12-1 and a bias circuit 12-2. The transfer conductance circuit 12-1 is generally configured using a differential amplifier as a base, and converts an input voltage into a current and outputs the current. At this time, a conversion coefficient is Gₘ. The bias circuit 12-2 supplies a driving current and an operation point potential to the transfer conductance circuit 12-1.

FIG. 3 illustrates an example of the configuration of a transistor circuit of the transfer conductance circuit 12-1 in FIG. 2. In FIG. 3, voltages VI+ and VI− are inputs of FIGS. 1 and 2, and currents IO− and IO+ are outputs of FIG. 2.

Also, transistors M1 and M2 and M3 and M4 constitute a differential transfer conductance stage. V_{BP1}, V_{BP2}, V_{BN1}, and V_{BN2} are outputs of the bias circuit 12-2, and VDD and VSS are power supply voltages. The transistors M11 and M12 are operated by the output V_{BP1} of the bias circuit 12-2, the transistors M13 and M14 are operated by the output V_{BP2} of the bias circuit 12-2, the transistors M5 and M6 are operated by the output V_{BN1} of the bias circuit 12-2, and the transistors M7 and M8 are operated by the output V_{BN2} of the bias circuit 12-2.

In an equilibrium state, the transistors M3 and M4 operate as resistor elements in a linear region, and improves linearity of Gₘ of a differential pair of the transistors M1 and M2. In a non-equilibrium state, either the transistor M3 or the transistor M4 is maintained in the linear region. For example, when a gate potential of the transistor M1 is high and a gate potential of the transistor M2 is low, the transistor M3 is operated in the linear region.

FIG. 4 illustrates an example of the configuration of a transistor circuit of the bias circuit of FIG. 2. In FIG. 4, an external input current I_{SET} is amplified by a current mirror stage comprising transistors M15 and M20, and supplied to transistors M24 and M30 and transistors M21 and M23.

The individual gate potentials V_{BN1}, V_{BN2}, V_{BP1}, and V_{BP2} of the transistors M27 and M29, M24 and M26, M22, and M21 and M23 are supplied to the transfer conductance circuit 12-1 of FIG. 3, and apply the driving current and the operation point potential of the transfer conductance circuit 12-1.

In this case, an effective V_{GS} voltage (Over-Drive voltage) of the transistor M30 is preferably set to become at least two times larger than an Over-Drive voltage of the transistors M24 and M29. Thereby, a cascode current source of a transfer conductance stage can decrease a voltage drop of a current source in an operation range in a saturation region, and expand an operation voltage range of the transfer conductance stage. This is applicable to a relationship between the transistors M21 and M21 and M23. An input VCOM sets a same phase output operation point potential of the transfer conductance stage.

FIG. 5 illustrates an example of the configuration of a transistor circuit of the coefficient setting circuit 16 serving as the current ratio setting mechanism of FIG. 1. In FIG. 5, an 8-bit current digital/analog converter (DAC) 16-1 is exemplified.

The current DAC 16-1 is composed of a current source circuit where a transistor size and a current are weighted by a binary number, and the individual bits become ON/OFF by individual control signals (gain control signals 2) k0 to k7. The control signals k0 to k7 correspond to the control signals 2 (adjustment of the gain K) in FIG. 1.

A reference current (frequency adjusting control signal 1) I_{REF} is input to a reference current source 16-2 of the DAC 16-1, and controls a reference current of the DAC 16-1.

In the case of N (=8) bits, with respect to the reference current I_{REF}, the output current I_{SET} is converted as represented by the following Equation 18.

$${I}_{SET} = \frac{{\sum }_{k = 0}^{N - 1} sgn ( {b}_{k} ) \cdot {2}^{k}}{{2}^{N} - 1} \cdot {I}_{REF} = \frac{{\sum }_{k = 0}^{7} sgn ( {b}_{k} ) \cdot {2}^{k}}{255} \cdot {I}_{REF} \qquad ( 18 )$$

In the primary low pass filter 10 of FIG. 1, the reference current I_{REF} is supplied to a Gₘ block (Gₘ₂) 14 of an output stage as a control current of the control signal 1 (frequency adjustment), and a current I_{SET} that is obtained by increasing the reference current I_{REF} coefficient times by a gain control signal is supplied to a Gₘ block (Gₘ₁) 12 of an input stage as a control current. As such, a frequency band can be controlled by the value of the reference current I_{REF}, and a flat gain can be controlled by the current I_{SET}.

### Second Embodiment of a Primary Filter

Next, the second embodiment of the primary filter will be described. In the first embodiment, Gₘ₁ of the input stage of FIG. 1 needs to have a current adjustment range wider than that of Gₘ₂ of the output stage. However, in general, the current adjustment range is restricted in the transfer conductance circuit 12-1.

The transfer conductance circuit 12-1 of FIG. 3 is partially used at the time of adjusting a gain, as compared with the case where the driving current is used only in the frequency adjustment in the conventional technology. Therefore, the frequency variable range is sacrificed by only the amount needed to adjust the gain. That is, a band width variable amount×a gain variable amount is restricted to be constant.

For example, when only the band is varied as in the conventional technology, if the band is variable in a range of four times and an ability of two times as a gain variable width is held, the band variable width decreases to 4÷2=2 times.

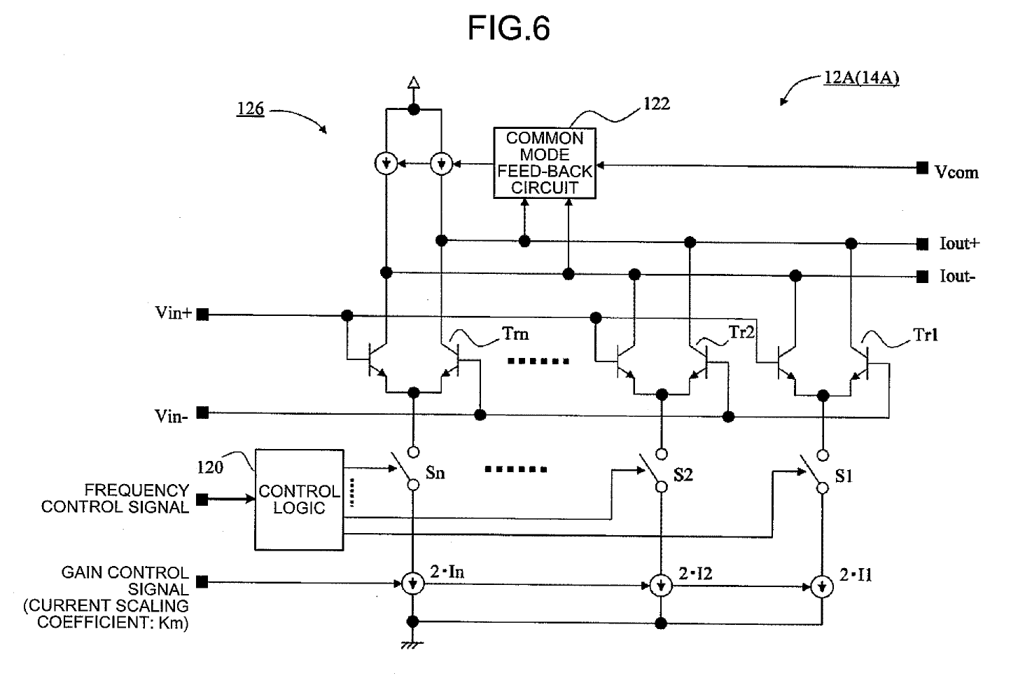

For this reason, a transfer conductance circuit where the gain adjustment is enabled while the frequency variable range in the conventional technology is secured is preferable. FIG. 6 illustrates the configuration of a complex control Gₘ amplifying circuit to remove the above restriction.

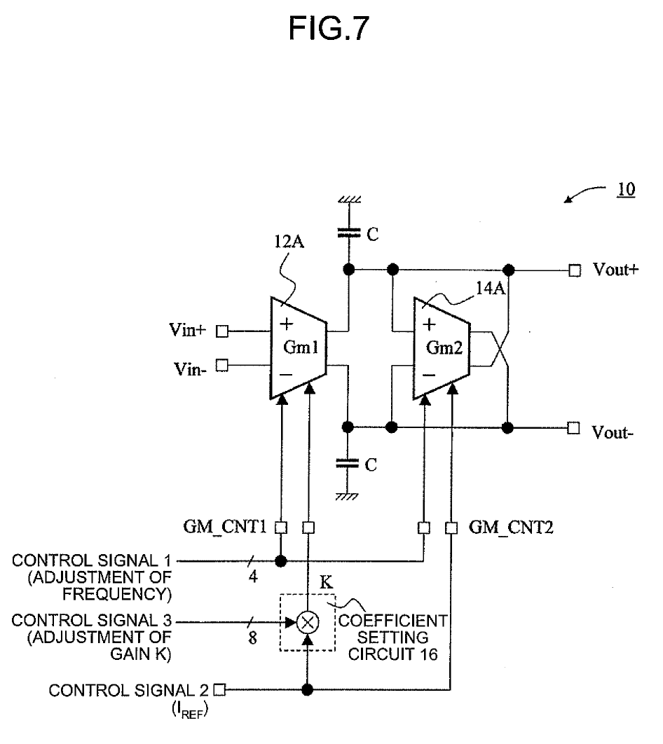

As described in detail below with reference to FIG. 7, the Gₘ amplifying circuit is a circuit where a bipolar transistor is configured as a base, and connects a plurality of differential transistor pairs Tr1 to Trn in parallel and drives the differential transistor pairs by different current sources 2·I₁ to 2·Iₙ, respectively.

The gain control signal Kₘ is a parameter used to adjust current values of the current sources 2·I₁ to 2·Iₙ, and can continuously change a value of Gₘ. The gain control signal Kₘ may be used in a discrete adjustment through a D/A converter.

Switches S₁ to Sₙ are switch circuits that individually turn on/off the current from the current sources 2·I₁ to 2·Iₙ, and can discretely change the value of Gₘ by combinations of turning on/off of the switches S₁ to Sₙ.

For example, if the Gₘ adjustment by the gain control signal Kₘ is used as a gain variation and the Gₘ adjustment by the switches S₁ to Sₙ is used as a frequency variation, the gain variation and the frequency variation can be performed in an available adjustment range without causing the mutual interference.

Of course, the gain control signal Kₘ may be used when the frequency is adjusted and the switches S₁ to Sₙ may be used when the gain is adjusted. An input VCOM sets a same phase output operation point potential of a transfer conductance stage, monitors output currents Iout of individual differential stages Tr1 to Trn in a common mode feedback circuit 122, and controls a collector current source 126 of the differential stages Tr1 to Trn.

A control logic circuit generates ON/OFF signals of the individual switches S₁ to Sₙ from the frequency control signal. In the configuration of FIG. 6, if it is assumed that q is an elementary charge of an electron, k is a Boltzmann constant, and T is an absolute temperature, a value of Gₘ is given by the following Equation 19.

$${G}_{m \text{-} total} = \frac{q}{k \cdot T} \cdot {K}_{m} \cdot {\sum }_{n = 1}^{N} sgn ( {S}_{n} ) \cdot {I}_{n} , \{ \begin{matrix}sgn ( {S}_{n} ) = 1 : ON \\ sgn ( {S}_{n} ) = 0 : OFF\end{matrix} \qquad ( 19 )$$

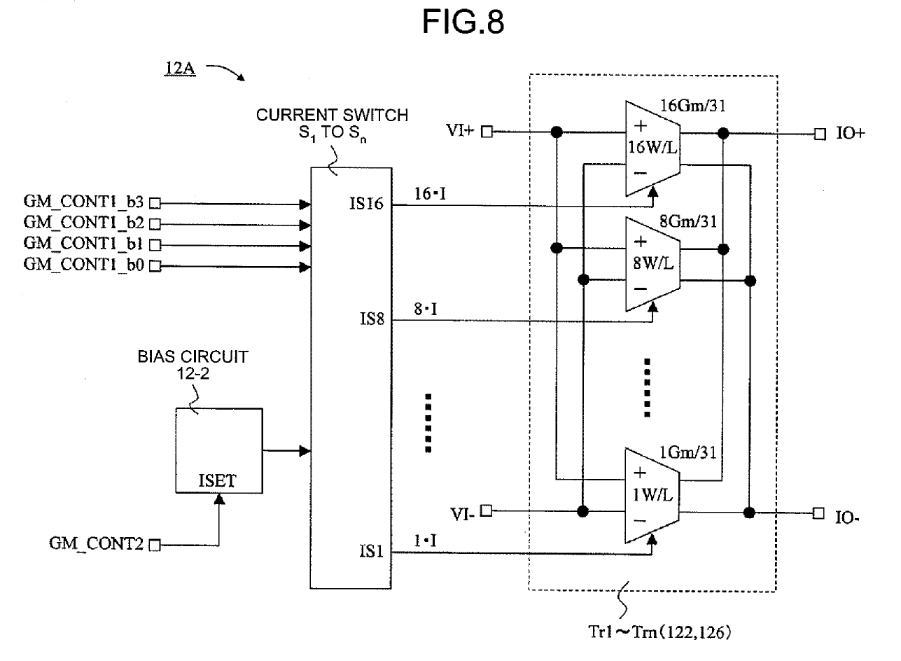

As such, in a complex control Gₘ amplifying circuit 12A, when the filter gain adjustment and the cutoff frequency adjustment are simultaneously performed, the parameters to be adjusted are divided. For this reason, as in the configuration of FIG. 1, the adjustments are independently performed. However, in regards to the adjustment range, a problem is not generated, and the complex control Gₘ amplifying circuit 12A is more practical as compared with the configuration of FIG. 1. The same circuit as that in FIG. 6 can be configured using a CMOS transistor. An example of a CMOS circuit that has low power consumption is described below with reference to FIGS. 8 to 10.

The specific description is given. FIG. 7 is a block diagram of an embodiment of a primary low pass filter using the complex control Gₘ amplifying circuit of the principle of FIG. 6. In FIG. 7, each Gₘ block comprises complex control Gₘ amplifying circuits 12A and 14A. The coefficient setting circuit 16 is the same as that described with reference to FIGS. 1 and 5.

In the embodiment of FIG. 7, the transfer conductance adjusting mechanism that is one system to the Gₘ block in the embodiment illustrated in FIGS. 1 and 2 is configured to have two systems of GM_CNT1 and GM_CTN2, and the two systems are independently adjusted.

For example, in GM_CNT1, the control signal 1 (frequency adjustment signal) is commonly applied to the Gₘ blocks 12A and 14A, and a cutoff frequency of the filter is adjusted by an absolute value of the transfer conductance. In GM_CNT2, a ratio current with respect to the reference current I_{REF} is supplied, and a gain is adjusted by a ratio of the transfer conductance.

The coefficient setting circuit 16 increases the control current of the control signal 2 coefficient times by a control signal 3 to adjust a gain. That is, the cutoff frequency becomes a function of the control signal 1 (frequency adjustment) of GM_CNT1, and the gain is applied with a relative ratio of the control signal 2 supplied to GM_CNT2.

FIG. 8 is a block diagram of the Gₘ block in FIG. 7, and the same components as those in FIG. 6 are denoted by the same reference numerals. In the embodiment, since the two-system transfer conductance adjusting mechanism is provided, the Gₘ block is called a Multiple-OTA (Operational Trans-conductance Amplifier).

As described in FIG. 6, transfer conductance circuit modules Tr1 to Trn are configured by connecting, in parallel, the individual transfer conductance circuits where the transistor size is weighted with a binary number. FIG. 8 illustrates an example of five bits.

The driving currents of the transfer conductance circuits Tr1 to Trn of the individual stages are supplied through the current switches S₁ to Sₙ. The current switches S₁ to Sₙ perform an ON/OFF operation for every bit, and select a desired transfer conductance value. In FIG. 8, an example of 4-bit control of GM_CONT1_b3 to GM_CONT_b0 is illustrated.

The entire driving current of the switches S₁ to Sₙ is supplied from the bias circuit 12-2 according to GM_CONT2.

In the case of the primary low pass filter of FIG. 7, the reference current I_{REF} is supplied to GM_CONT2 of the output stage Gₘ₂, and the current I_{sET} that is obtained by increasing the reference current I_{REF} coefficient times is supplied to GM_CONT2 of the input stage Gₘ₁.

GM_CONT_1 is commonly applied to the Gₘ blocks 12A and 14A. Accordingly, the cutoff frequency of the filter becomes a function of I_{REF} and GM_CONT, and the gain becomes a function of a ratio (gain coefficient K) between I_{REF} and I_{SET}.

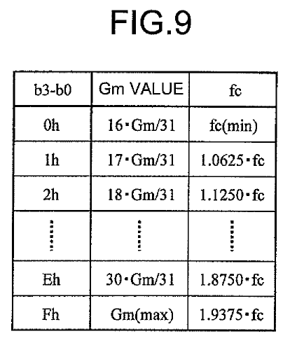

FIG. 9 illustrates an adjustment example of a Gₘ value with respect to values of GM_CONT1 (b0 to b3) and a cutoff frequency fc. FIG. 8 illustrates an example of when an uppermost transfer conductance stage is fixed (an ON state at all times) and lower 4 bits are set as adjustment bits. If the cutoff frequency fc (minimum) of when b0 to b3 are at “0h” is used as a reference, a cutoff frequency (maximum) of when b0 to b3 are at “Fh” becomes “1.9375·fc”, that is, almost two times as much. As a result, a range of 1 to 2 times can be adjusted by 16 stages.

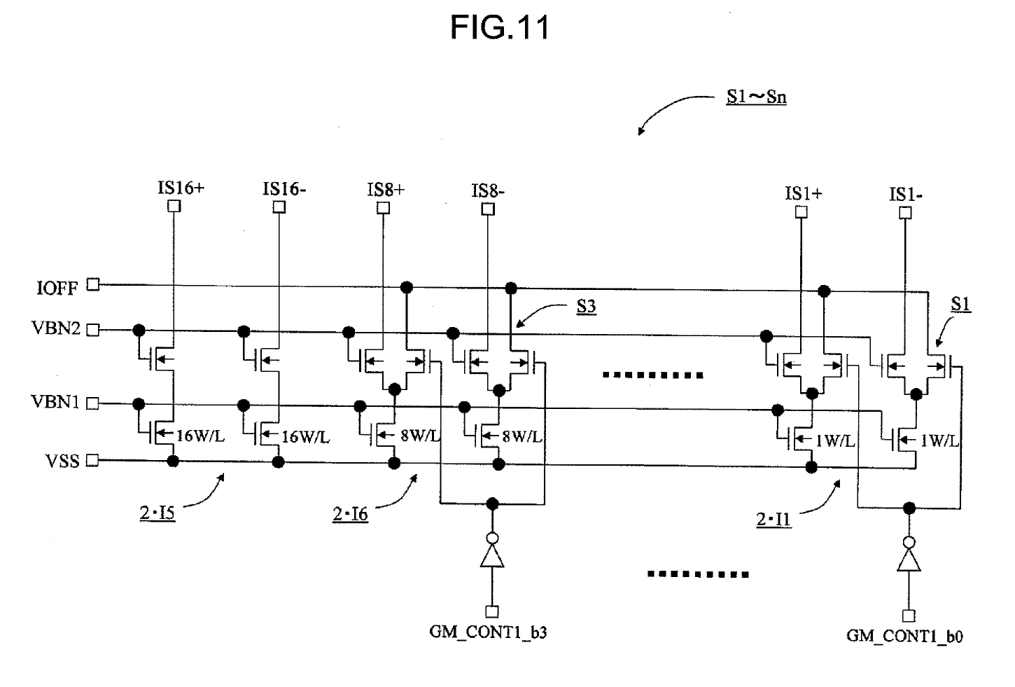

Next, an example of the configuration of a transistor circuit of a transfer conductance circuit module (binary number differential stage) of FIG. 8 is illustrated in FIG. 10, and an example of the configuration of a transistor circuit of the current switch in FIG. 8 is illustrated in FIG. 11.

In FIG. 10, a plurality of differential transistor pairs Tr1 to Trn where a CMOS is configured as a base are connected in parallel, and are driven by currents IS1 to IS6 of different current sources 2·I₁ to 2·Iₙ of FIG. 11, respectively.

The gain control signals Kₘ (GM_CONT1_b0 to b3) of FIG. 11 are parameters used to adjust current values of the current sources 2·I₁ to 2·I₅, and can continuously change the Gₘ value. The switches S₁ to S₅ are CMOS switch circuits that individually turn on/off the current sources 2·I₅ to 2·Iₙ, and discretely change the Gₘ value by combinations of turning on/off of the switches S₁ to Sₙ.

In this case, if the Gₘ adjustment by the gain control signal Kₘ is used as a gain variation and the Gₘ adjustment by the switches S₁ to Sₙ is used as a frequency variation, the gain variation and the frequency variation can be performed in an available adjustment range without causing the mutual interference.

In FIG. 10, the common mode feedback circuit 122 monitors an output current Iout of the differential stages Tr1 to Trn, and outputs a control signal I_{OFF}. The currents of the CMOS switches S₁ to S₃ of FIG. 11 are controlled by the control signal i_{OFF}, and the collector current source 126 of the differential stages Tr1 to Trn of FIG. 10 is controlled by the controlled current.

In this example, a control logic circuit is composed of a CMOS switch. As such, in the complex control Gₘ amplifying circuit 12A, when the filter gain adjustment and the cutoff frequency adjustment are simultaneously performed, the parameters to be adjusted are divided. For this reason, the adjustments are independently performed as compared with the first embodiment. However, in regards to the adjustment range, a problem can be prevented from being generated.

(Secondary Filter)

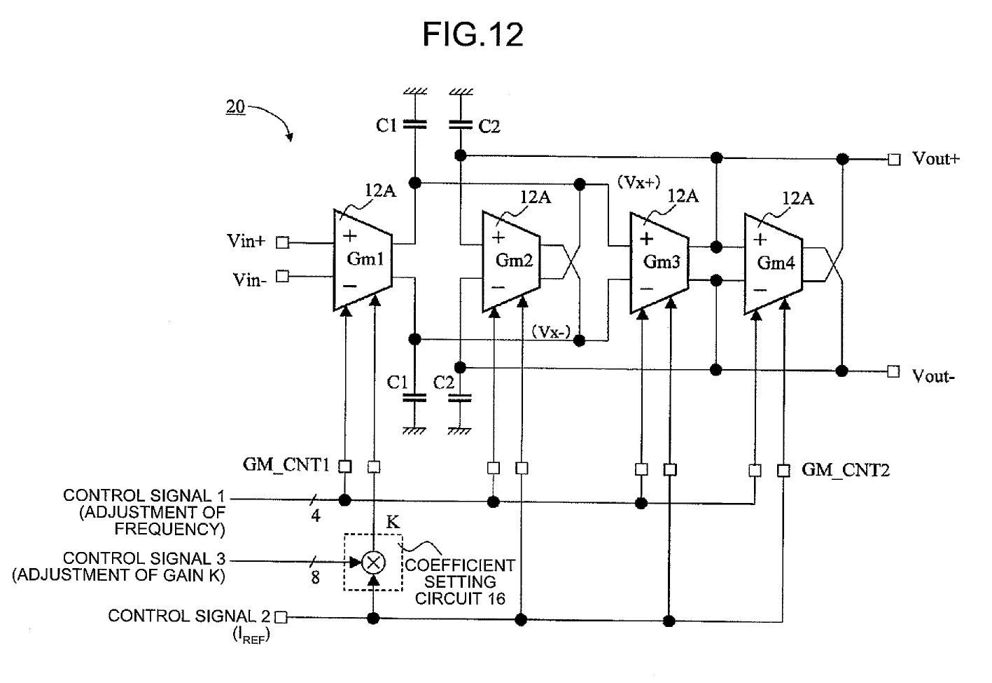

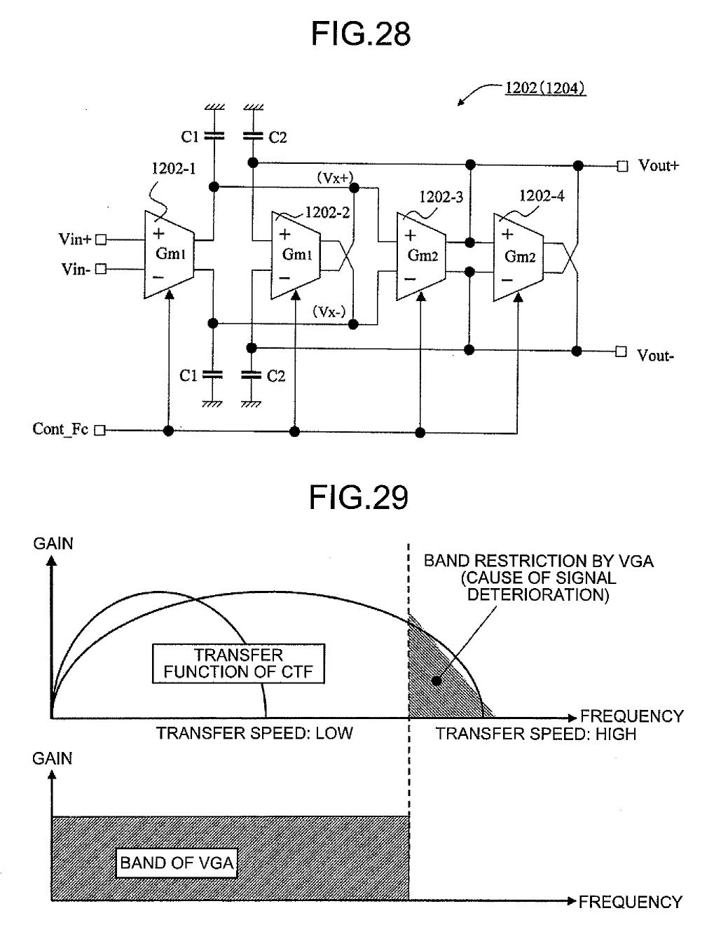

FIG. 12 illustrates the configuration of a Gₘ-C circuit of an embodiment of a secondary low pass filter of the invention. In FIG. 12, the same components at those in FIGS. 1 to 9 are denoted by the same reference numerals. In this example, in the configuration of the secondary filter described with reference to FIG. 28, each Gₘ block uses the Multiple-OTA 12A of FIGS. 6 to 8 described as the primary low pass filter.

In the current ratio setting circuit to adjust the gain, the same circuit as the coefficient setting circuit 16 described in FIG. 5 can be applied. The adjusting method of the frequency and the gain is the same as that in the case of the primary low pass filter that is described with reference to FIG. 6.

As compared with the secondary low pass filter according to the conventional technology that are illustrated in FIG. 28, the number of stages that a signal passes is not varied, and a gain adjusting function is added. In this case, in a state where a connection point potential of the output of the Gₘ₁ block and the capacitor C₁ is defined as Vₓ, a transfer function is analyzed. A virtual potential Vₓ and an output Vₒᵤₜ are as represented by the following Equations 20 and 21.

$$\begin{matrix}{V}_{x} = \frac{1}{S \cdot {C}_{1}} \cdot ( {G}_{m 1} \cdot {V}_{i n} - {G}_{m 2} \cdot {V}_{out} ) & ( 20 ) \\ {V}_{out} = \frac{1}{S \cdot {C}_{2}} \cdot ( {G}_{m 3} \cdot {V}_{X} - {G}_{m 4} \cdot {V}_{out} ) & ( 21 )\end{matrix}$$

From Equations 20 and 21, the transfer function is calculated as represented by the following Equation 22.

$$\begin{matrix}{T}_{LP 2} ( S ) = \frac{\frac{{G}_{m 1} \cdot {G}_{m 3}}{{C}_{1} \cdot {C}_{2}}}{{S}^{2} + \frac{{G}_{m 4}}{{C}_{2}} \cdot S + \frac{{G}_{m 2} \cdot {G}_{m 3}}{{C}_{1} \cdot {C}_{2}}} \\ = \frac{( \frac{{G}_{m 1}}{{G}_{m 2}} ) \cdot \frac{{G}_{m 2} \cdot {G}_{m 3}}{{C}_{1} \cdot {C}_{2}}}{{S}^{2} + \frac{{G}_{m 4}}{{C}_{2}} \cdot S + \frac{{G}_{m 2} \cdot {G}_{m 3}}{{C}_{1} \cdot {C}_{2}}} ≡ {K}_{0} \cdot \frac{{ω}_{0}^{2}}{{S}^{2} + \frac{{ω}_{0}}{Q} \cdot S + {ω}_{0}^{2}}\end{matrix} \qquad ( 22 )$$

Individual parameters of a resonant angular frequency ω₀, a gain K₀, and selectivity Q are given as represented by the following Equation 23.

$$\begin{matrix}{ω}_{0} = \sqrt{\frac{{G}_{m 2} \cdot {G}_{m 3}}{{C}_{1} \cdot {C}_{2}}} \\ {K}_{0} = \frac{{G}_{m 1}}{{G}_{m 2}} \\ Q = \frac{1}{{G}_{m 4}} \cdot \sqrt{\frac{{C}_{2}}{{C}_{1}} \cdot {G}_{m 2} \cdot {G}_{m 3}}\end{matrix} \} \qquad ( 23 )$$

In Equation 23, the frequency ω₀ is given by absolute values of Gₘ₂ and Gₘ₃. The gain K₀ is given independently from the frequency by the ratio of Gₘ₁ and Gₘ₂, similar to the case of the primary low pass filter.

The selectivity Q is given by a ratio of the capacitors C₁ and C₂. That is, since Gₘ₂, Gₘ₃, and Gₘ₄ cooperatively operate and the ratios thereof are constant, Gₘ₂, Gₘ₃, and Gₘ₄ do no affect a Q value. If only Gₘ₄ is varied, this can be used to adjust the Q value.

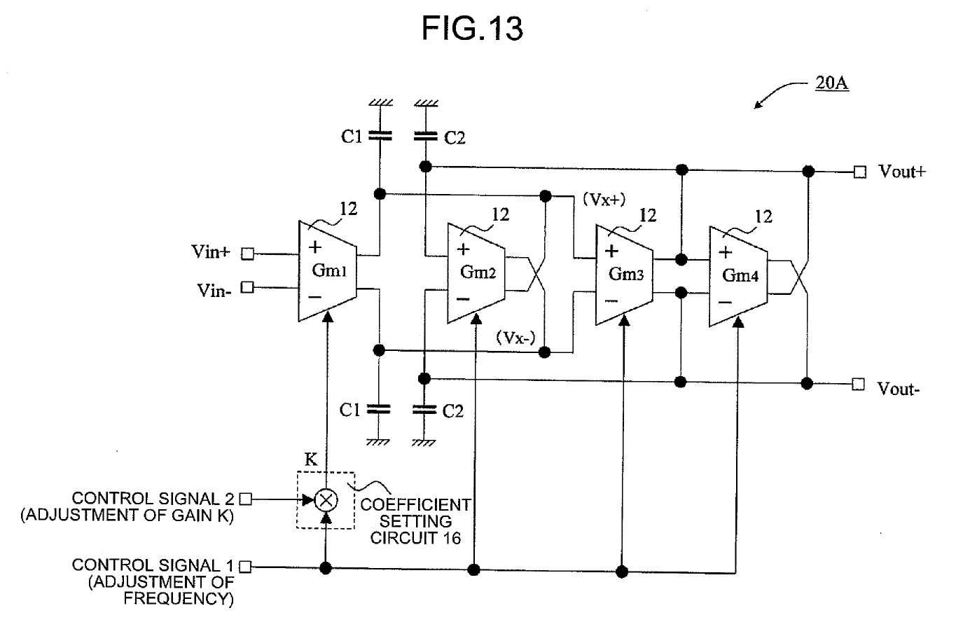

FIG. 13 illustrates the configuration of a Gₘ-C circuit 20A of another embodiment of a secondary low pass filter of the invention. In FIG. 13, the same components as those in FIGS. 1 to 9 are denoted by the same reference numerals. In this example, in the configuration of the secondary filter illustrated in FIG. 28, each Gₘ block uses the Gₘ block 12 of FIGS. 1 to 5 described in the primary low pass filter.

In the current ratio setting circuit to adjust the gain, the same circuit as the coefficient setting circuit 16 described in FIG. 5 can be applied. The adjusting method of the frequency and the gain is the same as that in the case of the primary low pass filter that is described with reference to FIG. 1.

As compared with the secondary low pass filter according to the conventional technology that are illustrated in FIG. 28, the number of stages that a signal passes is not varied, and a gain adjusting function is added. In the case, the frequency adjustment amount and the gain adjustment amount can be applied to only the current control.

(Equalizing Circuit)

Next, an equalizing circuit that uses a principle of the primary filter will be described. The CTF has a function as a waveform equalizer of a read signal, in addition to a function as the low pass filter. This is called pulse slimming or partial response equalization.

The equalizer is configured to have a characteristic of a High Pass Filter (HPF) or a Band Pass Filter (BPF), in addition to a Low Pass Filter (LPF). By appropriately changing the individual components of the LPF, BPF, and HPF, a desired gain-frequency characteristic is obtained.

The LPF has an all-pole type, but the BPF or the HPF has zero, that is, a root of a molecule multinomial expression of a transfer function. Among the seventh-order configuration of the CTF, any secondary block is configured as an equalizer. For example, as represented by the following Equation 24, a 2-pole/2-zero transfer function is given.

$${T}_{EQL} ( S ) = \frac{{K}_{0} \cdot \frac{{G}_{m 2} \cdot {G}_{m 3}}{{C}_{1} \cdot {C}_{2}} + {K}_{a} \cdot \frac{{G}_{m 4}}{{C}_{2}} \cdot S - {K}_{b} \cdot {S}^{2}}{{S}^{2} + \frac{{G}_{m 4}}{{C}_{2}} \cdot S + \frac{{G}_{m 2} \cdot {G}_{m 3}}{{C}_{1} \cdot {C}_{2}}} ≡ {K}_{0} \cdot {T}_{LP} ( S ) + {K}_{a} \cdot {T}_{BP} ( S ) - {K}_{b} \cdot {T}_{HP} ( S ) \qquad ( 24 )$$

In Equation 24, K₀ is a coefficient with respect to a low pass (LPF) component, Kₐ is a coefficient with respect to a band pass (BPF) component, and K_{b} is a coefficient with respect to a high pass (HPF) component.

Among them, in the use of the CTF, the coefficient K_{b} with respect to the HPF component is particularly important. This is called a boost function, and is used for pulse slimming or partial response equalization.

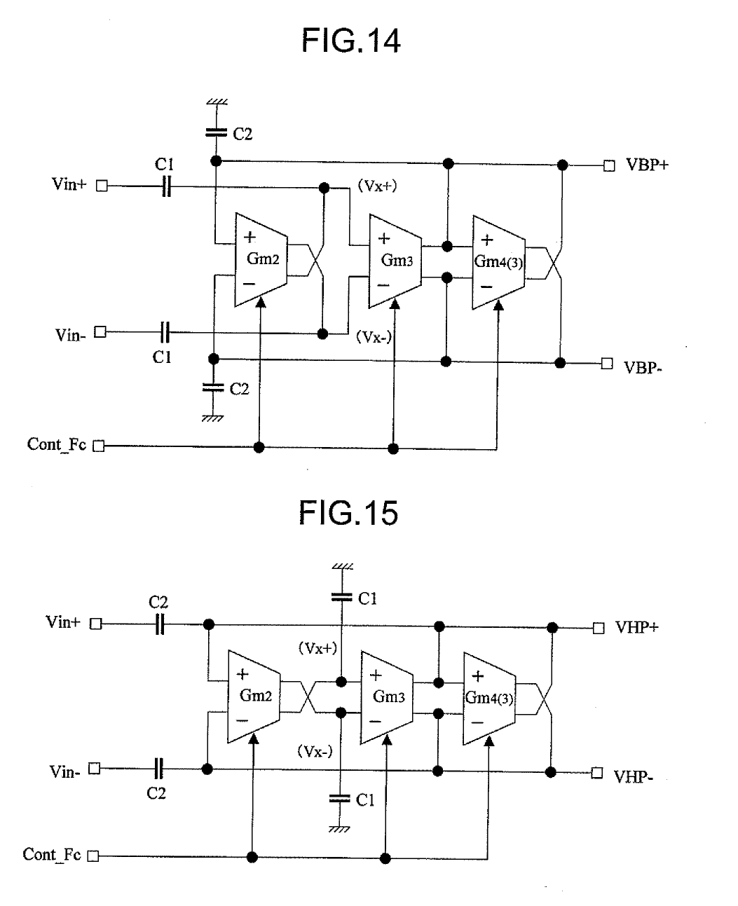

Before describing the equalizing circuit according to the embodiment, the configuration of the BPF and the HPF that are needed to constitute the equalizer is simply described using FIGS. 14 and 15.

FIG. 14 illustrates the configuration of a Gₘ-C circuit of a secondary band pass filter that serves as an equalizer element. With respect to the BPF, the configuration of the Gₘ-C circuit is derived, similar to the LPF. On the basis of the transfer function (Equation 7) of the secondary LPF, a transfer function of the BPF is given by the following Equation 25.

$$\begin{matrix}\frac{{V}_{BP} ( S )}{{V}_{i n} ( S )} = \frac{\frac{{G}_{m 4 ( 3 )}}{{C}_{2}} \cdot S}{{S}^{2} + \frac{{G}_{m 4 ( 3 )}}{{C}_{2}} \cdot S + \frac{{G}_{m 2} \cdot {G}_{m 3}}{{C}_{1} \cdot {C}_{2}}} \\ = \frac{\frac{{G}_{m 4 ( 3 )}}{S \cdot {C}_{2}}}{1 + \frac{{G}_{m 4 ( 3 )}}{S \cdot {C}_{2}} + ( \frac{{G}_{m 2}}{S \cdot {C}_{1}} ) \cdot ( \frac{{G}_{m 3}}{S \cdot {C}_{2}} )}\end{matrix} \qquad ( 25 )$$

Similar to the above-described case of the LPF, if a potential equation is made in consideration of an accumulated charge for every capacitance C, the following two relational expressions (Equation 26) can be obtained by an output Vₒᵤₜ and an interval operation point Vₓ, for every capacitance C.

$$\begin{matrix}{V}_{BP} = \frac{{G}_{m 3}}{S \cdot {C}_{2}} \cdot [ ( {V}_{i n} - \frac{{G}_{m 2}}{S \cdot {C}_{1}} \cdot {V}_{BP} ) - {V}_{BP} ] = \frac{{G}_{m 3}}{S \cdot {C}_{2}} \cdot ( {V}_{x} - {V}_{BP} ) \\ {V}_{x} = {V}_{i n} - \frac{{G}_{m 2}}{S \cdot {C}_{1}} \cdot {V}_{BP}\end{matrix} \} \qquad ( 26 )$$

FIG. 14 illustrates the configuration of a Gₘ-C circuit of a BPF that serves as an element of an equalizer derived from Equation 26.

In FIG. 14, the same components as those in the secondary low pass filter of FIG. 13 are denoted by the same reference numerals. As compared with the LPF of FIG. 13, it can be seen that Gₘ₁ of the input stage is opened and an input is enabled from the capacitor C₁.

FIG. 15 illustrates the configuration of a Gₘ-C circuit of a secondary low pass filter that serves as an equalizer element. With respect to the HPF, the configuration of the Gₘ-C circuit is derived, similar to the LPF. A transfer function of the secondary HPF is represented by the following Equation 27.

$$\begin{matrix}\frac{{V}_{HP} ( S )}{{V}_{i n} ( S )} = \frac{{S}^{2}}{{S}^{2} + \frac{{G}_{m 4 ( 3 )}}{{C}_{2}} \cdot S + \frac{{G}_{m 2} \cdot {G}_{m 3}}{{C}_{1} \cdot {C}_{2}}} \\ = \frac{1}{1 + \frac{{G}_{m 4 ( 3 )}}{S \cdot {C}_{2}} + ( \frac{{G}_{m 2}}{S \cdot {C}_{1}} ) \cdot ( \frac{{G}_{m 3}}{S \cdot {C}_{2}} )}\end{matrix} \qquad ( 27 )$$

Similar to the above-described cases of the LPF and BPF, if a potential equation is made in consideration of an accumulated charge for every capacitance C, the following two relational expressions (Equation 28) can be obtained by an output Vₒᵤₜ and an interval operation point Vₓ, for every capacitance C.

$$( 28 ) \\ \begin{matrix}{V}_{HP} = {V}_{i n } + \frac{{G}_{m 3}}{S \cdot {C}_{2}} \cdot ( - \frac{{G}_{m 2}}{S \cdot {C}_{1}} \cdot {V}_{HP} - {V}_{HP} ) = {V}_{i n} + \frac{{G}_{m 3}}{S \cdot {C}_{2}} \cdot ( {V}_{x} - {V}_{HP} ) \\ {V}_{x} = - \frac{{G}_{m 2}}{S \cdot {C}_{1}} \cdot {V}_{HP}\end{matrix} \}$$

FIG. 15 illustrates the configuration of a Gₘ-C circuit of a secondary HPF that serves as an element of an equalizer derived from Equation 28.

In FIG. 15, the same components as those in the secondary low pass filter of FIG. 13 are denoted by the same reference numerals. As compared with the LPF of FIG. 13, it can be seen that the Gₘ₁ of the input stage is opened and an input is enabled from the capacitor C₂.

The equalizing circuit is realized by combining the circuit elements of the BPF, the HPF, and the LPF that serve as the elements of the equalizer described above.

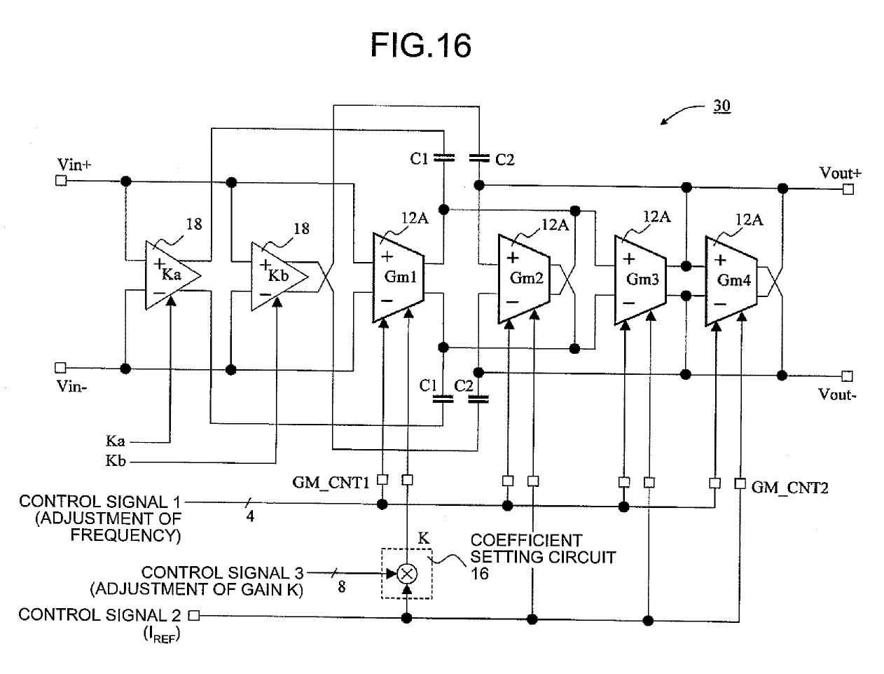

FIG. 16 illustrates the configuration of a Gₘ-C circuit of a first embodiment of an equalizing circuit of the invention. FIG. 16 illustrates an example of the configuration of a Gₘ-C circuit of a 2-pole/2-zero equalizer based on the configuration of a Gₘ-C circuit of the secondary BPF of FIG. 14, the secondary HPF of FIG. 15, and the secondary LPF of FIG. 12.

That is, an input Vᵢₙ is input to the Gₘ₁ (12A) of the input stage, and roots of the Gₘ₂ (12A) Gₘ₃ (12A) and Gₘ₄ (12A) of the next stages constitute the secondary low pass filter of FIG. 12. With respect to the input Vₐₙ, the Gₘ₁ of the input stage is opened from the amplifier (Kₐ) 18, and the roots that are input from the capacitor C₁ to the Gₘ₂ (12A) constitute the secondary BPF described in FIG. 14.

With respect to the input Vᵢₙ, the Gₘ₁ of the input stage is opened from the amplifier (K_{b}) 18, and the roots that are input from the capacitor C₂ to the Gₘ₂ (12A) constitute the secondary HPF described in FIG. 15. In this case, the gain Kₒ of the LPF component is given by a ratio of the Gₘ₁ and the Gₘ₂. The coefficient setting circuit 16 is as described in FIG. 5.

If the transfer function of an equalizing circuit 30 of FIG. 16 is analyzed, the transfer function is calculated as represented by the following Equation 29.

$${T}_{EQL} ( S ) = \frac{( \frac{{G}_{m 1}}{{G}_{m 2}} ) \cdot \frac{{G}_{m 2} \cdot {G}_{m 3}}{{C}_{1} \cdot {C}_{2}} + {K}_{a} \cdot ( \frac{{G}_{m 3}}{{G}_{m 4}} ) \cdot \frac{{G}_{m 4}}{{C}_{2}} \cdot S - {K}_{b} \cdot {S}^{2}}{{S}^{2} + \frac{{G}_{m 4}}{{C}_{2}} \cdot S + \frac{{G}_{m 2} \cdot {G}_{m 3}}{{C}_{1} \cdot {C}_{2}}} \qquad ( 29 )$$

In Equation 29, in a molecule multinomial expression, a ratio of Gₘ₃ and Gₘ₄ appears as a new term. Since the ratio causes a gain of a band-pass component and a Q value to be varied, the ratio needs to be set at high precision.

For example, in each pair of Gₘ₁ and Gₘ₂ and Gₘ₃ and Gₘ₄ since each output is common, each pair may be designed as a dual-input-type Gₘ stage that shares one common-mode feedback loop.

In this case, each Gₘ block is composed of the complex control Gₘ block 12A described in FIG. 6.

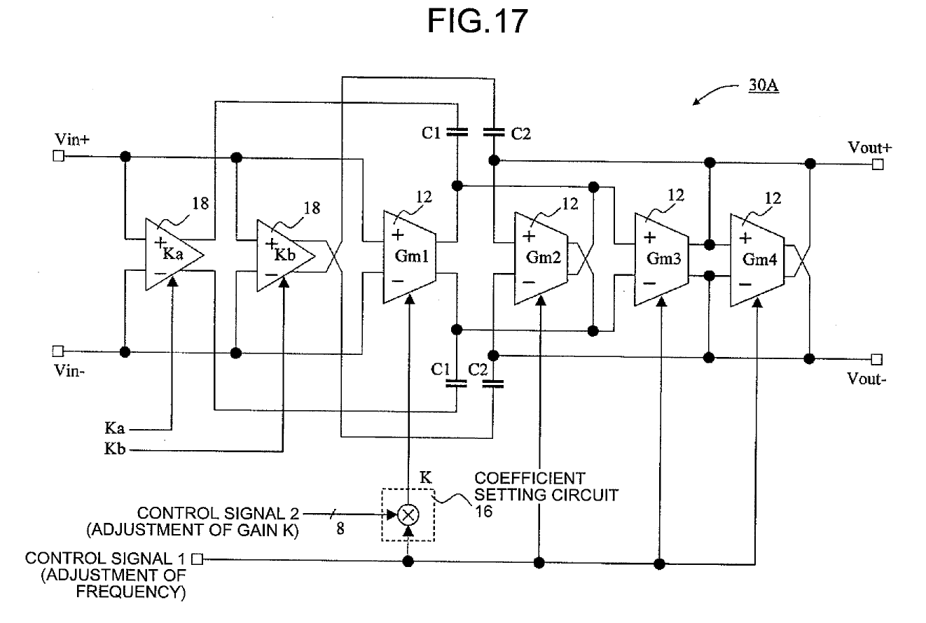

FIG. 17 illustrates an example of the configuration of a Gₘ-C circuit of a second embodiment of an equalizing circuit of the invention. FIG. 17 illustrates an example of a Gₘ-C circuit of a 2-pole/2-zero equalizer based on the configuration of a Gₘ-C circuit of the secondary BPF of FIG. 14, the secondary HPF of FIG. 15, and the secondary LPF of FIG. 13.

That is, similar to the case of FIG. 16, an input Vᵢₙ is input to the Gₘ₁ (12) of the input stage, and roots of the Gₘ₂ (12), Gₘ₃ (12), and Gₘ₄ (12) of the next stages constitute the secondary low pass filter of FIG. 13. With respect to the input Vᵢₙ, Gₘ₁ of the input stage is opened from the amplifier (Kₐ) 18, and the roots that are input from the capacitor C₁ to Gₘ₂ (12) constitute the secondary BPF described in FIG. 14.

With respect to the input Vᵢₙ, Gₘ₁ of the input stage is opened from the amplifier (K_{b}) 18, and the roots that are input from the capacitor C₂ to Gₘ₂ (12) constitute the secondary HPF described in FIG. 15. In this case, the gain Kₒ of the LPF component is given by a ratio of Gₘ₁ and Gₘ₂. The coefficient setting circuit 16 is as described in FIG. 5.

In this case, each Gₘ block is composed of the Gₘ block 12 described in FIG. 2. For this reason, the frequency adjustment amount and the gain adjustment amount can be applied to only the current control.

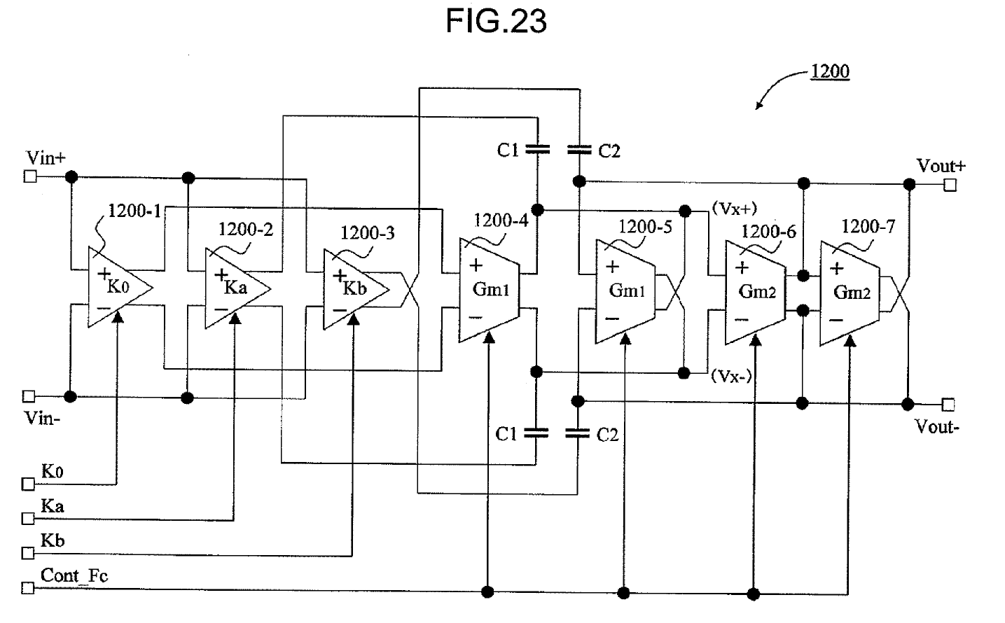

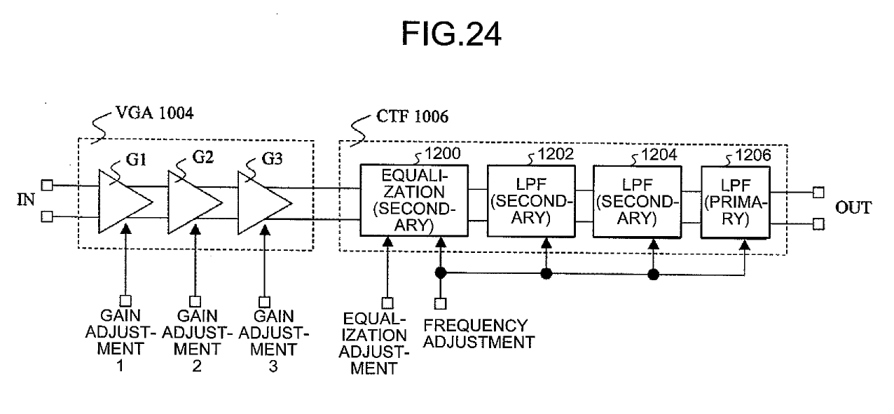

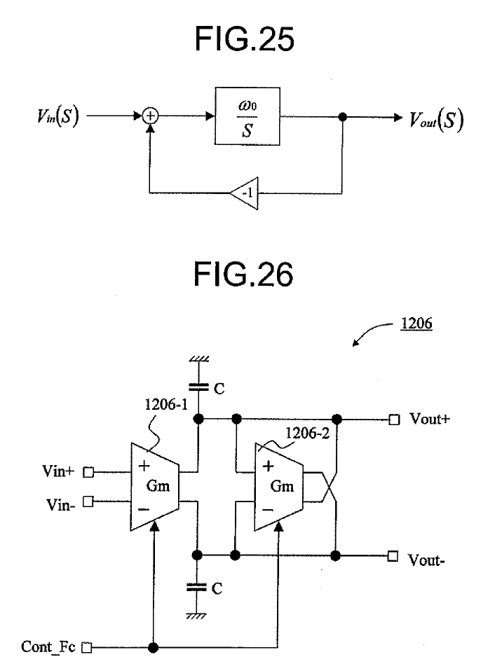

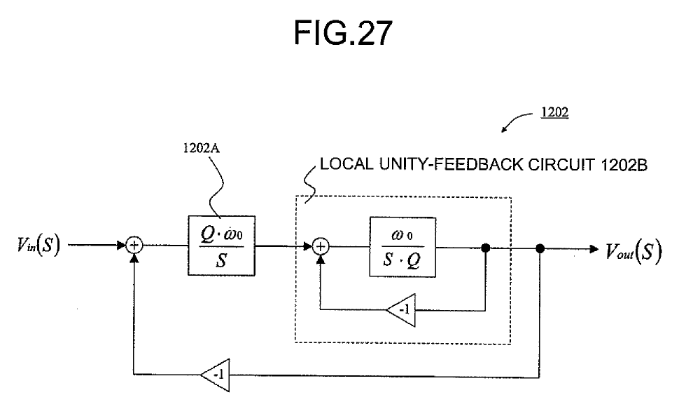

If the configurations of the secondary equalizers according to the embodiment described in FIGS. 16 and 17 and the conventional technology described in FIG. 23 are compared with each other, it can be seen from FIGS. 16 and 17 that the amplifying stage K₀ serving as the signal pass element in FIG. 23 is removed. This is because the gain K0 is given by the ratio of Gₘ₁ and Gₘ₂ in the configuration of FIGS. 16 and 17. This corresponds to an effect of the embodiment.

(Signal Reproducing Apparatus)

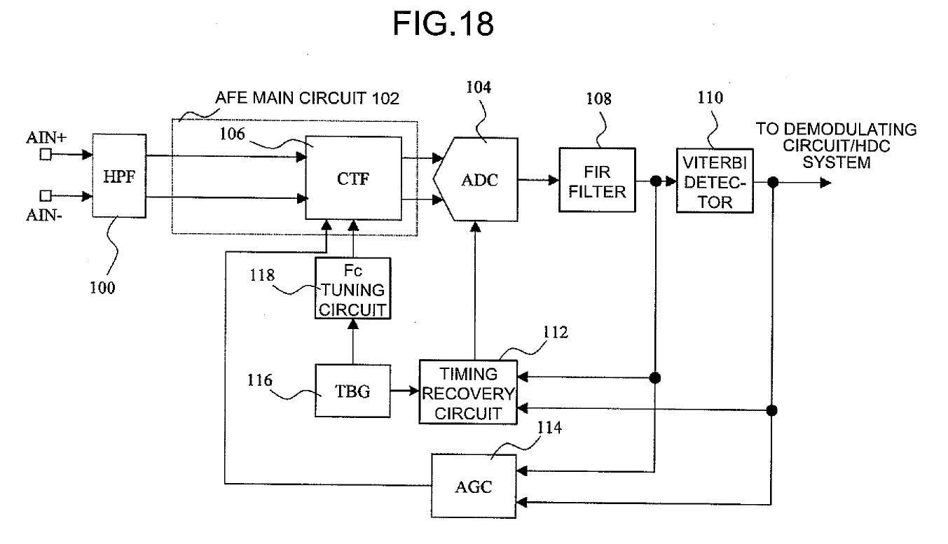

FIG. 18 is a block diagram of an embodiment of a read channel circuit of the invention. A reproduction signal from a magnetic head (not illustrated) is input to a high pass filter (HPF) 100, and a low frequency component is cut. An output of the high pass filter 100 is input to an analog front end (AFE) circuit 102.

In the embodiment, the AFE circuit 102 is composed of a continuous time filter (CTF) 106. That is, the VGA in the conventional technology is removed. The CTF 106 adjusts amplitude of a read signal to an optimal value according to an external control signal, adjusts a cutoff frequency, and equalizes a waveform.

The output of the CTF 106 is converted into a digital value by an Analog/Digital Converter (ADC) 104, and input to a Finite Impulse Response (FIR) filter 108. The FIR filter 108 equalizes a PR channel and outputs an equalizing result to a Viterbi detector 110. The Viterbi detector 110 performs maximum-likelihood decoding and outputs a decoding result to a demodulating circuit of a Hard Disk Controller (HDC).

Meanwhile, a timing recovery circuit 112 corrects a clock of a Time Base Generator (TBG) 116 by an output of the FIR filter 108 and an output of the Viterbi detector 110, and corrects a sample clock of the ADC 104.

An Automatic Gain Control (AGC) circuit 114 adjusts a gain of the CTF 106 from the output of the FIR filter 108 and the output of the Viterbi detector 110. A frequency adjusting (Fc Tuning) circuit 118 generates a frequency adjustment signal from the clock of the time base generator 116 and adjusts the frequency of the CTF 106.

The CTF 106 causes each LPF stage to have the above-described gain adjusting function so as to replace the VGA function in the conventional technology.

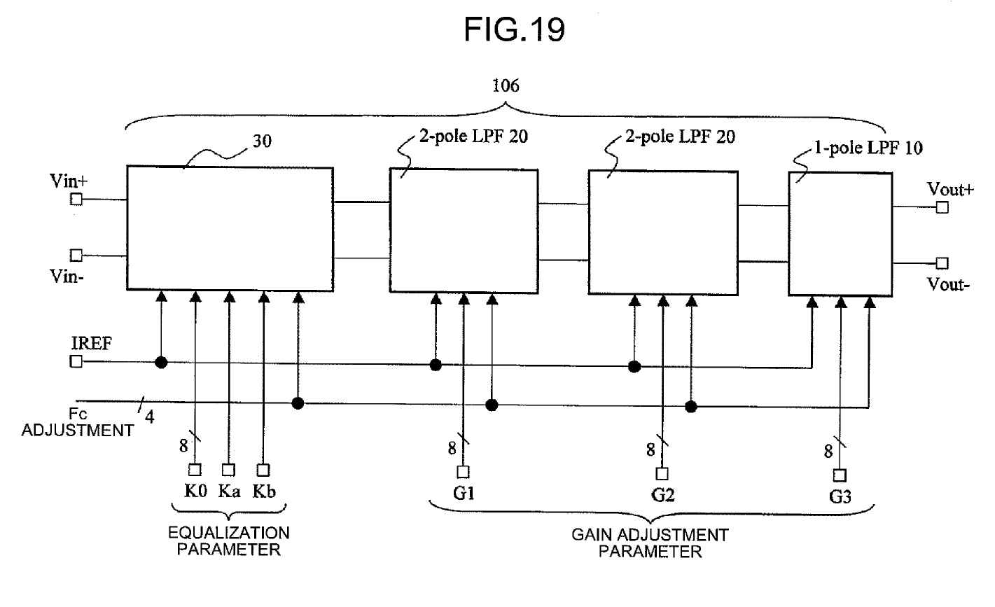

FIG. 19 is a block diagram of a first embodiment of the CTF 106 of FIG. 18. As illustrated in FIG. 19, the CTF 106 comprises the equalizer (Function-Block) 30 described in FIG. 16, a two-stage configuration of the secondary LPF 20 described in FIG. 12, and the primary LPF 10 described in FIG. 7.

The reference current I_{REF} and the Fc adjustment signal from the Fc adjusting circuit 118 are supplied to the equalizer (Function-Block) 30, the secondary LPF 20, and the primary LPF 10. The predetermined equalization parameters Kₒ, Kₐ, and K_{b} are input to the equalizer (Function-Block) 30, and the gain adjustment signals G1, G2, and G3 are input from the AGC 114 to the secondary LPF 20 and the primary LPF 10.

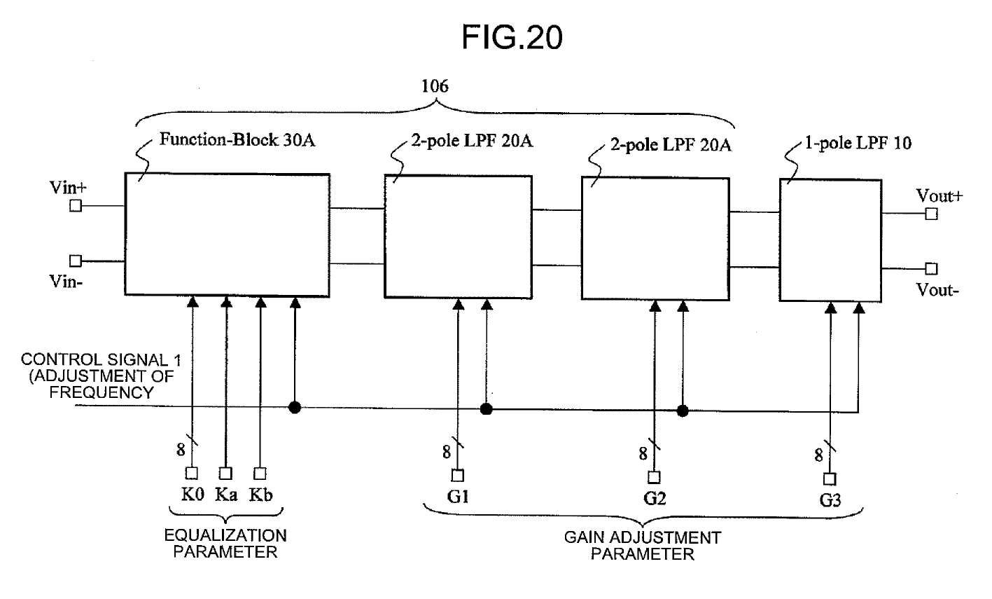

FIG. 20 is a block diagram of a second embodiment of the CTF 106 of FIG. 18. As illustrated in FIG. 20, the CTF 106 comprises an equalizer (Function-Block) 30A described in FIG. 17, a two-stage configuration of the secondary LPF 20A described in FIG. 13, and the primary LPF 10 described in FIG. 1.

The Fc adjustment signal (control signal 1) is supplied from the Fc adjusting circuit 118 to the equalizer (Function-Block) 30A, the secondary LPF 20A, and the primary LPF 10. The predetermined equalization parameters Kₒ, Kₐ, and K_{b} are input to the equalizer (Function-Block) 30A, and the gain adjustment signals G1, G2, and G3 are input from the AGC 114 to the secondary LPF 20A and the primary LPF 10.

As such, in the AFE module, each LPF stage of the CTF 106 is configured to have a gain adjusting function, thereby realizing the configuration where the VGA needed in the conventional technology is removed. Thereby, even though the number of signal passing stages in the AFE module is equal to the number in the CTF in the conventional technology or smaller than the number in the CTF due to the removable of the equalizer, the VGA function in the conventional technology can be achieved.

Since the influence of the band restriction by the VGA can be removed by removing the VGA, a signal quality can be easily secured at the time of a high-speed transmission.

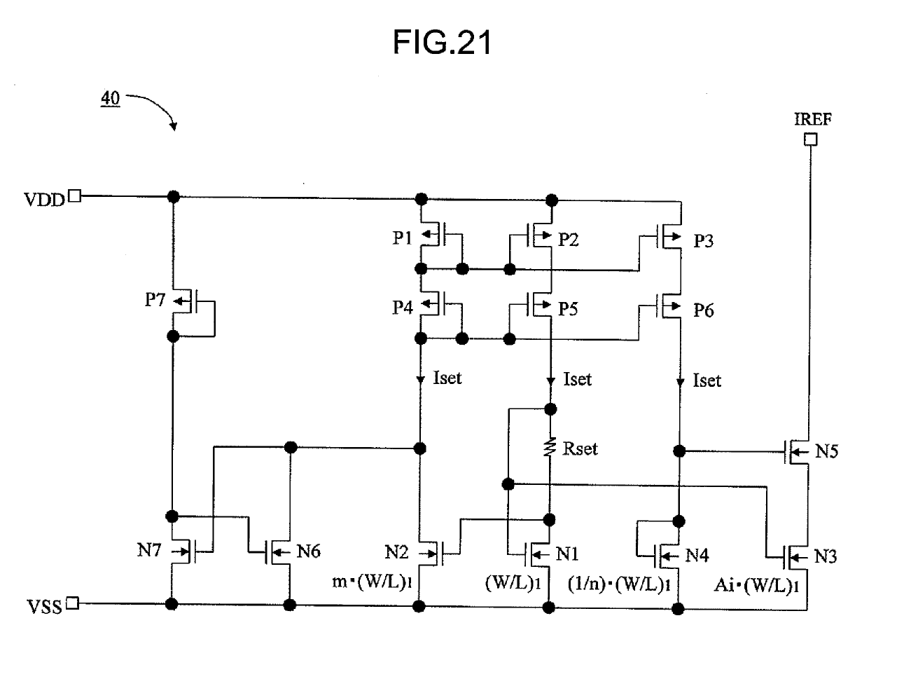

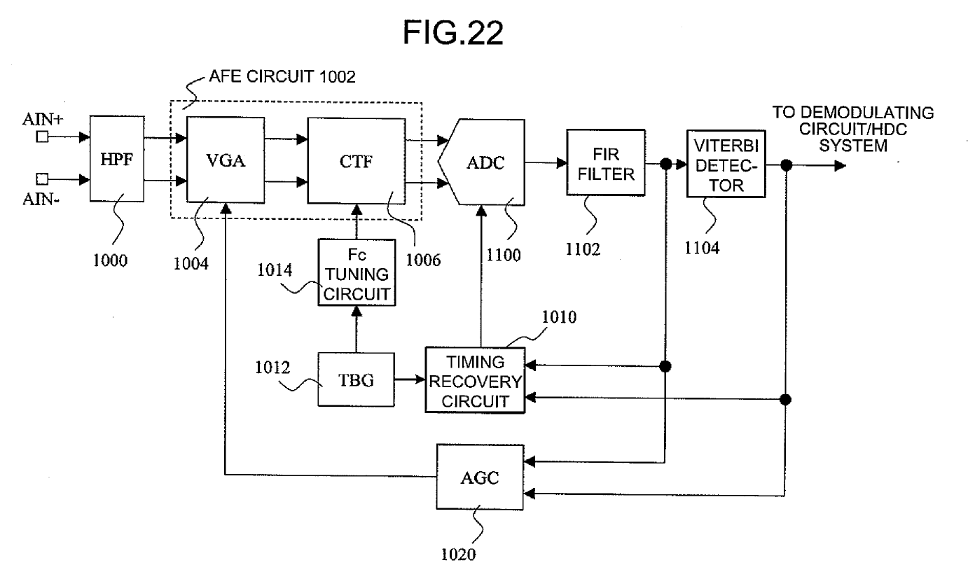

Next, the reference current I_{REF} that is used in the embodiment will be described. FIG. 21 is a circuit diagram of a reference current source 40 suitable for the CTF 106 of the invention, which illustrates an example where the reference current source 40 is composed of a CMOS transistor.

Since the transfer conductance Gₘ in the embodiment is basically varied by only the control signal, it is preferable that the transfer conductance do not depend on the device parameter of the transistor or the power supply voltage. For this reason, the reference current I_{REF} needs to be supplied to compensate for the variation of Gₘ.

FIG. 21 illustrates an example of a reference current source circuit 40 for Gₘ stabilization to achieve the above object. In FIG. 21, the gate widths are applied to the NMOS transistors N1 and N4 on the basis of the transistor N1. The gate width of the transistor N2 is m times larger than the gate width of the transistor N1, and a current Iₛₑₜ is generated by a difference of each V_{GS} and resistance Rₛₑₜ.

All of PMOS transistors P1 to P6 have the same size, and each current has the same Iₛₑₜ value. At this time, if a reference bias effect is ignored, a voltage drop Rₛₑₜ·Iₛₑₜ of the resistor Rₛₑₜ is as represented by Equation 30.

$${R}_{set} \cdot {I}_{set} = {V}_{GS 1} - {V}_{GS 2} = \sqrt{\frac{2 \cdot {I}_{set}}{{μ}_{n} \cdot {C}_{ox} \cdot {( \frac{W}{L} )}_{1}}} \cdot ( 1 - \frac{1}{\sqrt{m}} ) \qquad ( 30 )$$

From Equation 30, the current Iₛₑₜ is calculated as represented by Equation 31.

$${I}_{set} = \frac{2}{{μ}_{n} \cdot {C}_{ox} \cdot {( \frac{W}{L} )}_{1}} \cdot \frac{1}{{R}_{set}^{2}} \cdot {( 1 - \frac{1}{\sqrt{m}} )}^{2} \qquad ( 31 )$$

The voltage drop (Rₛₑₜ·Iₛₑₜ) of the resistor Rₛₑₜ needs to be set to be smaller than Vₜₕₗ.

From the relation of V_{GS3}=V_{GS1}, the output current I_{REF} is determined by the ratio Aᵢ (current amplification factor of Current Mirror) of the gate widths of the transistors N1 and N3, as represented by the following Equation 32.

I_{REF}=Aᵢ·set (32)

Next, a Gₘ value is analyzed using the I_{REF}. As a most simple example, Gₘ in an equilibrium state of a general source coupling differential amplifier of a CMOS is given by the following Equation 33.

$${( {G}_{m} )}_{vi = 0} = \sqrt{2 \cdot {μ}_{n} \cdot {C}_{ox} \cdot {( \frac{W}{L} )}_{G} \cdot {I}_{SS}} \qquad ( 33 )$$

In Equation 33, 2·Iₛₛ is a power supply current of a differential pair. If the I_{REF} calculated previously in Equation 32 is used for the driving current of a Gₘ stage as the Iₛₛ and substituted for Equation 33, Gₘ is as represented by the following Equation 34.

$${( {G}_{m} )}_{vi = 0} = \frac{2}{{R}_{set}} \cdot ( 1 - \frac{1}{\sqrt{m}} ) \cdot \sqrt{{A}_{i} \frac{{( \frac{W}{L} )}_{G}}{{( \frac{W}{L} )}_{1}}} \qquad ( 34 )$$

From Equation 34, since a ratio m or Aᵢ of the gate width is fixed, Gₘ is proportional to only an inverse of the resistance Rₛₑₜ, and becomes a value that does not depend on the power supply voltage or the device parameter of the CMOS.

The condition of the transistor N4 that applies a gate potential of the cascode output stage N5 is described. The gate length of the transistor N4 becomes n times larger than the gate length of the transistor N1. Accordingly, the V_{GS} is represented by the following Equation 35.

$${V}_{GS 4} = \sqrt{\frac{2 \cdot {I}_{set}}{{μ}_{n} \cdot {C}_{ox} \cdot \frac{1}{n} \cdot {( \frac{W}{L} )}_{1}}} + {V}_{th} \qquad ( 35 )$$

In order to make the current source to be effective, the transistor N3 needs to be maintained in the saturation region. For this reason, the condition where the V_{DS} of the transistor N3 is an effective value (=OverDrive voltage) or more of the V_{GS} is set. The V_{DS} of the transistor N3 is given by the following Equation 36.

$${V}_{DS 3} = {V}_{GS 4 -} {V}_{GS 5} ( = {V}_{GS 3} ) = \sqrt{\frac{2 \cdot {I}_{set}}{{μ}_{n} \cdot {C}_{ox} \cdot {( \frac{W}{L} )}_{1}}} \cdot ( \sqrt{n} - 1 ) \qquad ( 36 )$$

Under the condition of n 4, the V_{DS3} becomes the OverDrive voltage or more, and the saturation region is secured. The circuit configuration using the transistor N4 is effective to expand an operation voltage range of the cascode current output stage.

### Another Embodiment

In the above-described embodiment, the example where the signal reproducing apparatus of the magnetic disk apparatus is applied has been described. However, the invention can be applied to other storage apparatuses, such as an optical disk apparatus, or a communication apparatus.

According to an embodiment of the present invention, to a first voltage/current converting circuit, a third signal generated from a first control signal and a second control signal for gain adjustment is input, and to a second voltage/current converting circuit the first control signal is input, and thus it is possible to realize a filter that controls the frequency and the gain independently.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A filter comprising:
a first voltage to current convertor configured to convert a first input voltage into a current using a transfer conductance as a conversion coefficient;
a capacitor connected to an output terminal of the first voltage to current convertor;
a second voltage to current convertor connected to the first voltage to current convertor and the capacitor, and configured to convert a second input voltage into a current using a transfer conductance as a conversion coefficient;
a coefficient setting module [configured to adjust the transfer conductance of the first voltage to current convertor using a first control signal and a second control signal indicative of gain adjustment (this is not clear . . . ) and to generate a third signal to be used in gain adjustment, wherein
the output terminal of the first voltage to current convertor is connected to an output terminal of the second voltage to current convertor, the output terminal of the second voltage to current convertor configured to output a signal inverted with respect to a signal from the first voltage to current convertor,
the second voltage to current convertor is configured to receive the first control signal, and
a frequency band is adjusted by the first control signal.

2. The filter of claim 1, further comprising:
a third voltage to current convertor connected to the second voltage to current convertor and configured to convert a third input voltage into a current using a transfer conductance as a conversion coefficient;
a fourth voltage to current convertor connected to the third voltage to current convertor and configured to convert a fourth input voltage into a current using a transfer conductance as a conversion coefficient; and
a second capacitor connected to an output terminal of the third voltage to current convertor,
wherein the third and fourth voltage to current convertors are configured to receive the first control signal.

3. The filter of claim 2, further comprising:
a first voltage amplifier configured to adjust a gain of an intermediate frequency component; and
a second voltage amplifier configured to adjust a gain of a high frequency component,
wherein a gain of a low frequency component is adjusted with the third signal of the coefficient setting circuit.

4. The filter of claim 1, wherein the coefficient setting module comprises a multiplier configured to multiply the first control signal by the second control signal to generate the third signal.

5. The filter of claim 4, wherein the coefficient setting module is a current digital to analog convertor configured to output an output current computed by multiplying an input signal from an external source by a digital signal from an external source.

6. A filter comprising:
a first voltage to current convertor configured to convert a first input voltage into a current using a transfer conductance as a conversion coefficient;
a capacitor connected to an output terminal of the first voltage to current convertor;
a second voltage to current convertor connected to the first voltage to current convertor and the capacitor, and configured to convert a second input voltage into a current using a transfer conductance as a conversion coefficient;
a coefficient setting module configured to adjust the transfer conductance of the first voltage to current convertor from a first control signal and a second control signal indicative of gain adjustment and to generate a third signal to be used in gain adjustment, wherein
the output terminal of the first voltage to current converting circuit is connected to an output terminal of the second voltage to current convertor, the output terminal of the second voltage to current convertor configured to output a signal inverted with respect to a signal from the first voltage to current convertor,
the first voltage to current convertor is configured to receive the third signal and a fourth signal for frequency adjustment, and
the second voltage to current convertor is configured to receive the first control signal and the fourth signal.

7. The filter of claim 6, further comprising:
a third voltage to current convertor connected to the second voltage to current convertor and configured to convert a third input voltage into a current using a transfer conductance as a conversion coefficient;
a fourth voltage to current convertor connected to the third voltage to current convertor and configured to convert a fourth input voltage into a current using a transfer conductance as a conversion coefficient; and
a second capacitor connected to an output terminal of the third voltage to current convertor,
wherein the third and fourth voltage to current convertors are configured to receive the first control signal.

8. The filter of claim 7, further comprising:
a first voltage amplifier configured to adjust a gain of an intermediate frequency component; and
a second voltage amplifier configured to adjust a gain of a high frequency component,
wherein a gain of a low frequency component is adjusted with the third signal of the coefficient setting module.

9. The filter of claim 6, wherein the coefficient setting module comprises a multiplier configured to multiply the first control signal by the second control signal to generate the third signal.

10. The filter of claim 9, wherein the coefficient setting module is a current digital to analog convertor configured to output an output current computed by multiplying an input signal from an external source by a digital signal from an external source.

11. The filter of claim 6, wherein each of the first and second voltage to current convertors comprises:
a plurality of weighted transfer conductance modules;
a bias module configured to output a current according to the fourth signal; and
a current switch configured to receive the first control signal or the third signal and to selectively output the current from the bias circuit to the plurality of transfer conductance circuits.

12. A continuous time filter for waveform equalization comprising:
a first low pass filter;
a second low pass filter; and
a variable equalizer,
wherein each of the first low pass filter, the second low pass filter, and the variable equalizer comprises a filter comprising:
a first voltage to current convertor configured to convert a first input voltage into a current using a transfer conductance as a conversion coefficient;
a capacitor connected to an output terminal of the first voltage to current convertor;
a second voltage to current convertor connected to the first voltage to current convertor and the capacitor, and configured to convert a second input voltage into a current using a transfer conductance as a conversion coefficient;
a coefficient setting module configured to adjust the transfer conductance of the first voltage to current convertor from a first control signal and a second control signal indicative of gain adjustment and to generate a third signal to be used in gain adjustment, wherein
the output terminal of the first voltage to current convertor is connected to an output terminal of the second voltage to current convertor, the output terminal of the second voltage to current convertor is configured to output a signal inverted with respect to a signal from the first voltage to current convertor,
the second voltage to current convertor is configured to receive the first control signal, and
a frequency band is adjusted by the first control signal.
